(19) United States
(12) Patent Application Publication
(10) Pub. No.: US 2026/0172154 A1
(43) Pub. Date: Jun. 18, 2026

(54) ALIGNMENT OF BANDWIDTH PART BETWEEN USER EQUIPMENT AND NETWORK ENTITY

(71) Applicant: QUALCOMM Incorporated, San Diego, CA (US)

(72) Inventors: Mostafa KHOSHNEVISAN, San Diego, CA (US); Heechoon LEE, San Diego, CA (US); Jing SUN, San Diego, CA (US)

(21) Appl. No.: 18/986,650

(22) Filed: Dec. 18, 2024

(51) Int. Cl. H04L 1/1867; H04L 5/00; H04W 72/1273

(52) U.S. Cl. CPC H04L 1/1896; H04L 5/0005; H04W 72/1273

(57) ABSTRACT

Certain aspects of the present disclosure provide techniques for wireless communications. An example method includes obtaining, from a network entity, a downlink control information (DCI) including an indication of a bandwidth part (BWP) switch, the indication of the BWP switch including a BWP indicator, the BWP indicator including an indication of a second BWP different than a first BWP, the first BWP being a currently active BWP; sending, to the network entity, a hybrid automatic repeat request (HARQ) feedback; and communicating with the network entity on the second BWP after a configured amount of time configured for the BWP switch, wherein the configured amount of time starts after sending the HARQ feedback.

### FIELD OF THE DISCLOSURE

Aspects of the present disclosure relate to wireless communications, and more particularly, to techniques for alignment of bandwidth part (BWP) between user equipment and network entity.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining, from a network entity, a downlink control information (DCI) comprising an indication of a bandwidth part (BWP) switch, the indication of the BWP switch comprising a BWP indicator, the BWP indicator comprising an indication of a second BWP different than a first BWP, the first BWP being a currently active BWP; sending, to the network entity, a hybrid automatic repeat request (HARQ) feedback; and communicating with the network entity on the second BWP after a configured amount of time configured for the BWP switch, wherein the configured amount of time starts after sending the HARQ feedback.

Certain aspects provide a method for wireless communications by a network entity. The method includes sending a DCI comprising an indication of a BWP switch, the indication of the BWP switch comprising a BWP indicator, the BWP indicator comprising an indication of a second BWP different than a first BWP, the first BWP being a currently active BWP; obtaining a HARQ feedback; and communicating with a user equipment on the second BWP after a configured amount of time configured for the BWP switch, the BWP switch being based at least in part on the HARQ feedback.

Certain aspects provide a method of wireless communications by a user equipment. The method includes obtaining, from a network entity, a DCI in accordance with a downlink DCI format and comprising scheduling information for a physical downlink shared channel (PDSCH); obtaining the PDSCH in accordance with the scheduling information, the PDSCH comprising a medium access control (MAC) control element (CE), the MAC CE comprising an indication of a BWP switch, the indication of the BWP switch comprising a BWP indicator, the BWP indicator comprising an indication of a second BWP different than a first BWP, the first BWP being a currently active BWP; sending, to the network entity, a HARQ feedback for the PDSCH; and communicating with the network entity on the second BWP after a first configured amount of time configured for the BWP switch.

Certain aspects provide a method of wireless communications by a user equipment. The method includes obtaining, from a network entity, a DCI in accordance with an uplink DCI format and comprising scheduling information for a physical uplink shared channel (PUSCH), the DCI comprising an indication of a BWP switch, the indication of the BWP switch comprising a BWP indicator, the BWP indicator comprising an indication of a second BWP different than a first BWP, the first BWP being a currently active BWP; sending the PUSCH in accordance with the scheduling information; and communicating with the network entity on the second BWP after a configured amount of time after sending the PUSCH.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example of a plurality of bandwidth parts (BWPs).

FIG. 6 depicts an example of a BWP switch.

FIGS. 7A and 7B depict examples of a BWP switch.

FIG. 8 depicts an example of aligning BWP between a user equipment and a network entity for a BWP switch.

FIG. 9 depicts another example of aligning BWP between a user equipment and a network entity for a BWP switch.

FIG. 10 depicts a process flow for communications in a network between a user equipment and a network entity.

FIG. 11 depicts another example of aligning BWP between a user equipment and a network entity for a BWP switch.

FIG. 12 depicts another example of aligning BWP between a user equipment and a network entity for a BWP switch.

FIG. 13 depicts another example of aligning BWP between a user equipment and a network entity for a BWP switch.

FIG. 14 depicts a method for wireless communications.

FIG. 15 depicts another method for wireless communications.

FIG. 16 depicts another method for wireless communications.

FIG. 17 depicts another method for wireless communications.

FIG. 18 depicts aspects of an example communications device.

FIG. 19 depicts aspects of an example communications device.

### DETAILED DESCRIPTION

Aspects of the present disclosure provide apparatuses, methods, processing systems, and computer-readable mediums for alignment of BWP between user equipment and network entity.

Certain wireless communications systems, such as 5G New Radio (NR) systems and/or future wireless communications technologies, allow a user equipment to use a subset of a carrier bandwidth as a way to save power and increase flexibility of configuration. For example, the user equipment may use one or more BWPs for wireless communication, rather than a whole carrier bandwidth. A BWP is a contiguous set of resource blocks (RBs) and a subset of a carrier bandwidth, where each RB covers 12 consecutive subcarriers in the frequency domain. One or more BWPs (e.g., up to 4 BWPs) may be configured for the user equipment, and one of these BWPs (encompassing a subset of a carrier bandwidth) may be subsequently activated for communication. Monitoring only the subset of the carrier bandwidth may allow the user equipment to save power based on, for example, the reduced amount of radio frequency (RF) and baseband signal processing, when compared to monitoring the whole carrier bandwidth. The UE may have an active BWP in the uplink (referred to as an uplink BWP) and an active BWP in the downlink (referred to as a downlink BWP).

A UE may be indicated to switch from communicating on one configured BWP (referred to as a source BWP) to another configured BWP (referred to as a target BWP). This is referred to as BWP switching. BWP switching can be done for a variety of reasons, such as load balancing, power conservation, resource allocation, or the like. BWP switching can be triggered via lower-layer signaling, such as a DCI that schedules a PDSCH or a PUSCH. BWP switching can also be triggered by a timer, such as a BWP inactivity timer that indicates for the UE to switch to a target (e.g., default) BWP after a period of inactivity on a source (e.g., current) BWP. The UE may be expected to begin communication on the target BWP after a configured amount of time sometimes referred to as a BWP switching delay.

The lower-layer signaling to indicate a BWP, or other signaling associated with a BWP switch, can fail for various reasons. For example, a UE may implement certain procedures that may be proprietary or transparent to the network, such as antenna switching for diversity or multiple-subscriber communication, which may lead to failure to receive DCI indicating a BWP switch. As another example, the UE may fail to detect or decode a physical downlink control channel (PDCCH) that carries the DCI. As another example, the UE may receive what the UE perceives to be a PDCCH, and may detect a successful decoding of the PDCCH according to an error check on the perceived PDCCH, but this may be a “false positive” in which the network did not send a PDCCH. In such situations, the network may assume that the UE has switched to the target BWP when the UE has not actually switched to the target BWP. Alternatively, the UE may switch to a target BWP in accordance with a false positive when the network expects the UE to remain on a source BWP. These two conditions are referred to as an out-of-synchronization (OOS) status between the UE and the network. During the OOS status, failure of communications between the UE and the network may occur, leading to radio link failure, latency in communications, and a reduction in reliability.

Aspects of the present disclosure relate generally to avoidance of an OOS status in connection with BWP switching. Some aspects more specifically provide switching between BWPs based on an acknowledgment (ACK) associated with either DCI that carries a BWP switch indication or a PDSCH scheduled by the DCI. For example, in some aspects, the UE applies a BWP switching delay after transmitting an ACK for the DCI, and switches to the target BWP after the BWP switching delay. In some aspects, the UE applies a BWP switching delay after receiving the DCI, and transmits the ACK on the target BWP after switching to the target BWP. In these examples, the DCI may be a non-scheduling DCI. In some aspects, the UE receives a scheduling DCI and performs a BWP switch in accordance with the scheduling DCI only if the UE successfully decodes (and thus transmits an ACK for) a PDSCH scheduled by the scheduling DCI.

Aspects of the present disclosure may provide one or more of the following potential technical advantages. By switching between BWPs based on an ACK associated with the DCI that carries the BWP switch indication, an OOS status is avoided since the ACK indicates that the DCI was successfully received, reducing the likelihood of the network incorrectly assuming a successful BWP switch. This reduces the occurrence of radio link failure and latency, and improves reliability. Similarly, switching between BWPs based on an ACK associated with the PDSCH scheduled by a scheduling DCI (and applying the BWP switching delay after the ACK) achieves a common understanding of whether the scheduling DCI was successfully received and decoded, thereby reducing the occurrence of radio link failure and latency, and improving reliability.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

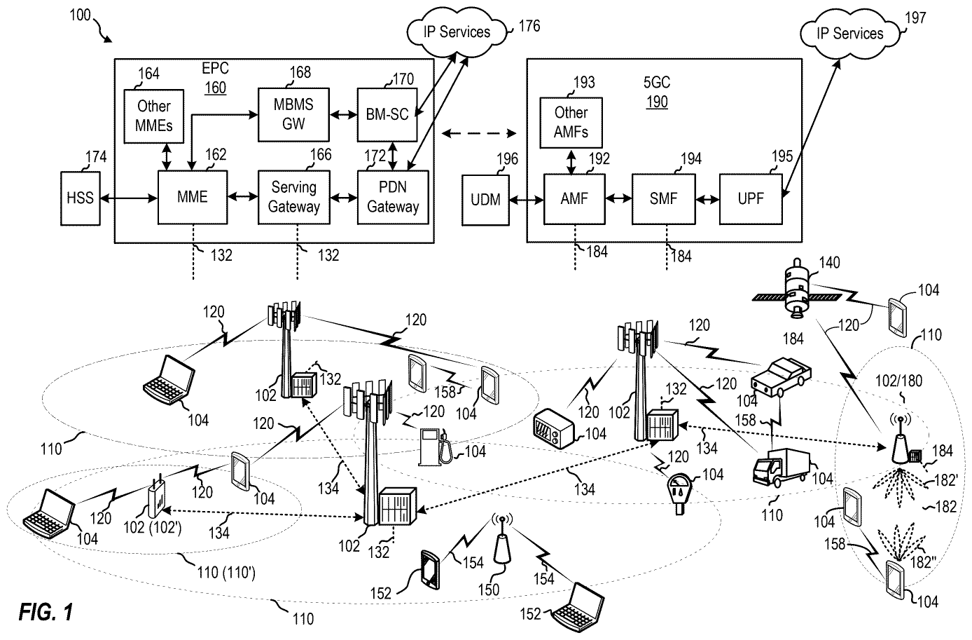

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

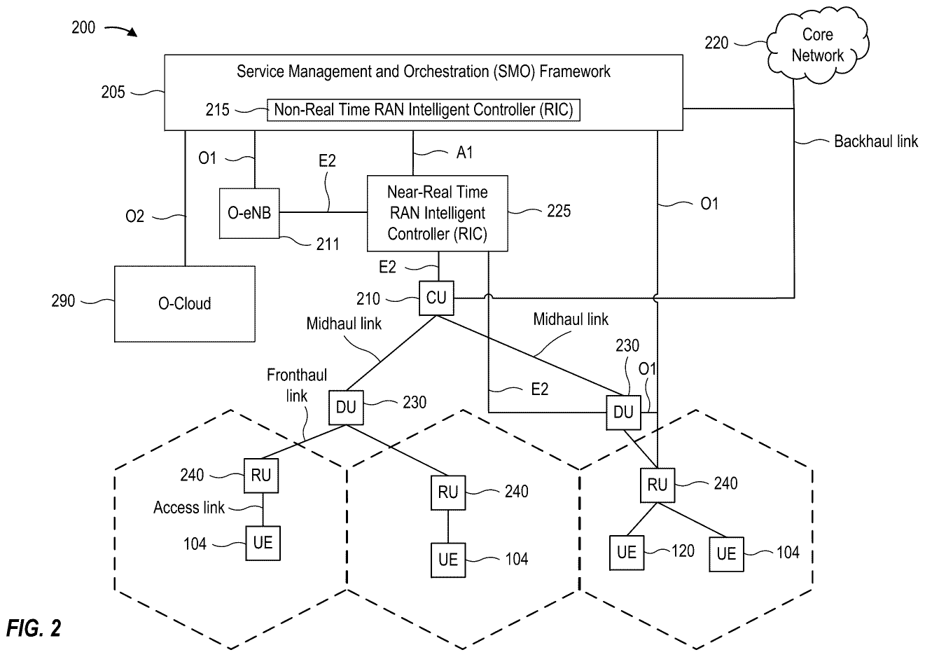

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1(FR1 ) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5 GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit - User Plane (CU-UP)), control plane functionality (e.g., Central Unit - Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

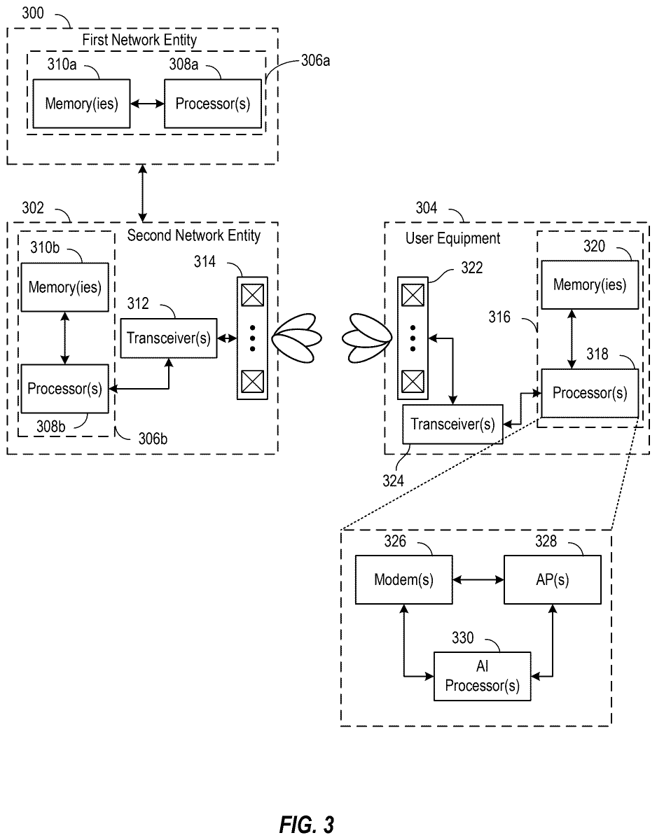

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

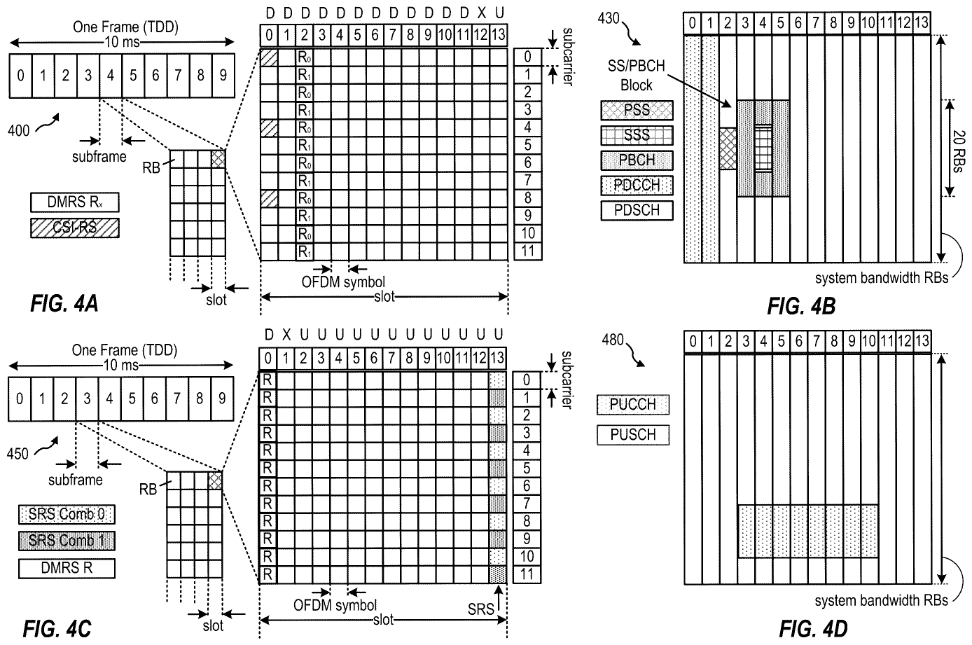

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Bandwidth Parts and Bandwidth Part Switching

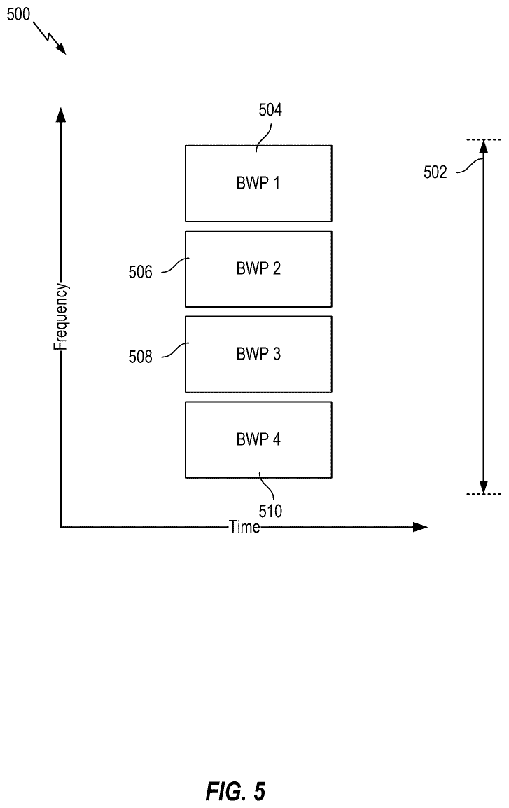

FIG. 5 depicts an example 500 of a plurality of BWPs. As depicted, a BWP is a subset of a carrier bandwidth 502. In certain aspects, multiple, such as up to a maximum of four, BWPs can be defined in the downlink (DL) and the uplink (UL). First BWP 504, second BWP 506, third BWP 508, and fourth BWP 510 are depicted in FIG. 5. For FDD, a timeline for the BWP switch described herein can be specific to DL or UL. For TDD, when the network indicates a BWP switch, a BWP may be switched for both DL and UL. While first BWP 504, second BWP 506, third BWP 508, and fourth BWP 510 are depicted in FIG. 5 as being configured as non-overlapped and of equal bandwidth, in some aspects, two BWPs may have different bandwidths and/or be overlapped.

Amongst the defined BWPs, only one BWP may be active at a given moment in the DL, and only one BWP may be active at a given moment in the UL. For example, a user equipment does not expect any data or information on a PDSCH, a PDCCH, or a CSI-RS outside the active DL BWP (and there may be only one active DL BWP). Moreover, the user equipment does not send any data or information on PUSCH, PUCCH, or SRS outside the active UL BWP (and there may be only one active UL BWP). A BWP switch may be performed by one of several different ways. For example, a BWP switch can be triggered using PDCCH such as DCI, where a specific BWP can be activated by a BWP indicator in DCI Format 0_1 (for UL) and DCI Format 1_1 (for DL). As another example, a BWP switch can be triggered by a BWP inactivity timer. As another example, a BWP switch can be triggered by RRC signaling. As another example, a BWP switch can be triggered by a UE's MAC entity itself upon initiation of a random access procedure.

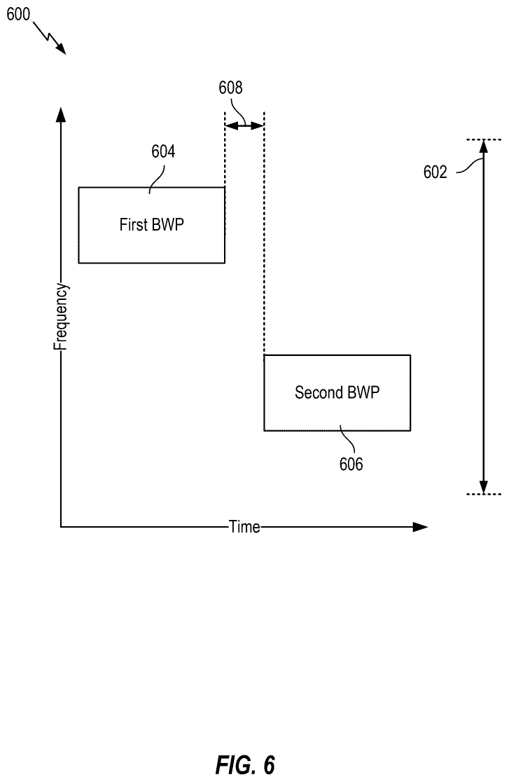

FIG. 6 depicts an example 600 of a BWP switch. The example 600 includes first BWP 604 and second BWP 606, where each of the first BWP 604 and the second BWP 606 is a respective (e.g., different) subset of a carrier bandwidth 602. In certain aspects, the first BWP 604 may be a source BWP, and the second BWP 606 may be a target BWP. In the time domain, the first BWP 604 and the second BWP 606 may be separated by at least a configured amount of time, a BWP switching delay 608. A UE can receive a PDSCH communication or transmit a PUSCH communication on the target BWP (e.g., the second BWP 606 of FIG. 6) after the BWP switching delay 608. In certain aspects, the UE is not expected (e.g., required) to transmit or receive data during the BWP switching delay 608.

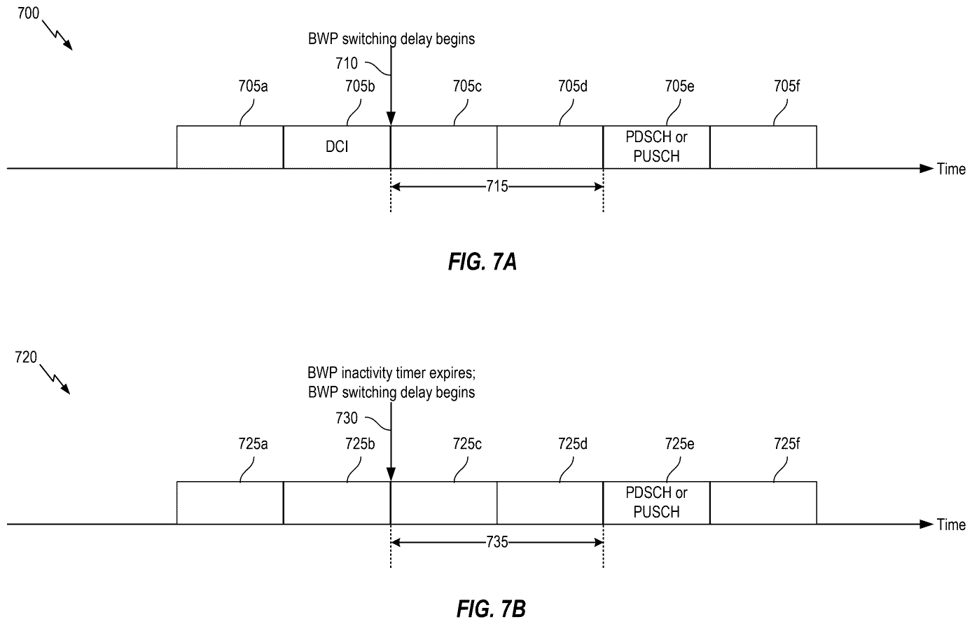

FIGS. 7A and 7B depict examples of a BWP switch. Particularly, FIGS. 7A and 7B depict example timelines 700 and 720 of a BWP switch. Example timeline 700 of FIG. 7A depicts a first timeline associated with a DCI-based BWP switch. Example timeline 720 of FIG. 7B depicts a second timeline associated with a timer-based BWP switch.

As depicted in FIG. 7A, example timeline 700 for the DCI-based BWP switch includes slots 705a-f. In slot 705b, a DCI indicating a BWP switch for a new BWP may be received at a user equipment. Accordingly, a BWP switching delay 715 begins at 710. In the depicted example, the user equipment may be able to receive PDSCH or transmit PUSCH on the new BWP starting in slot 705e. For example, the user equipment may not transmit or receive (depending on whether the BWP is a downlink BWP or an uplink BWP) any data or information during the BWP switching delay 715, which spans slots 705c and 705d in the example shown in FIG. 7A.

As depicted in FIG. 7B, example timeline 720 for the timer-based BWP switch includes slots 725a-f. After slot 725b, the timer (BWP inactivity timer) for a previous active BWP may expire at 730, at which point in time a BWP switching delay 735 may begin. The BWP inactivity timer may be configured by a network entity. The user equipment may be able to receive a PDSCH communication or transmit a PUSCH communication on a new BWP, such as a default BWP, starting in slot 725e. For example, the user equipment may not transmit or receive (depending on whether the BWP is a downlink BWP or an uplink BWP) any data or information during the BWP switching delay 735, which spans slots 725c and 725d in the example shown in FIG. 7B.

### Aspects Related to Alignment of Bandwidth Part Between User Equipment and Network Entity

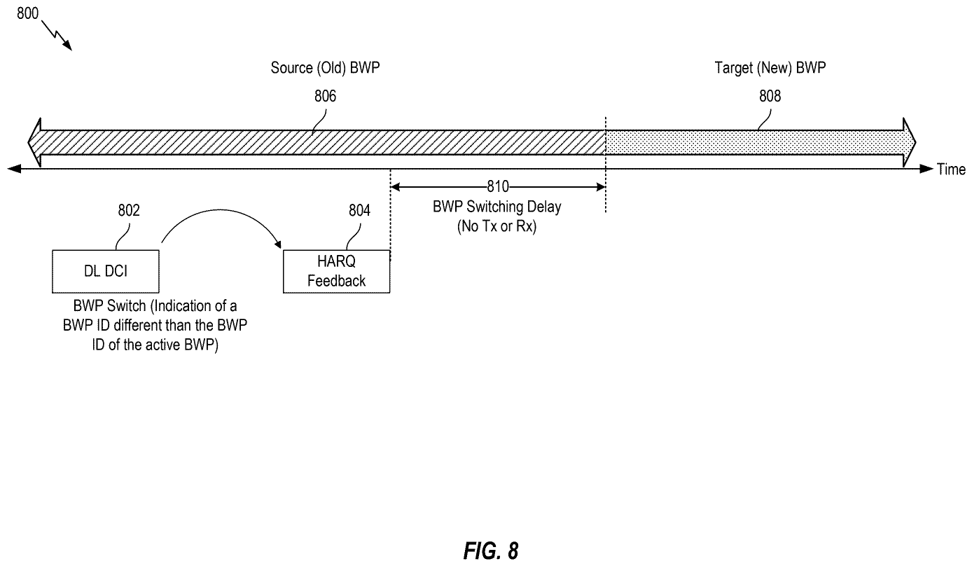

FIG. 8 depicts an example 800 of aligning BWP between a user equipment and a network entity for a BWP switch. In the depicted example 800, a user equipment obtains, from a network entity, a DCI 802 including an indication of a BWP switch, for example, in accordance with a DL DCI format. For example, the indication of the BWP switch may include a BWP indicator. The BWP indicator may include an indication of a second BWP different than a first BWP, where the first BWP may be a currently active BWP. An example of an indication of a BWP may be an identifier such as a BWP ID. In the depicted example, the first BWP is source BWP 806 (which also may be referred to as “old” BWP), and the second BWP is target BWP 808 (which also may be referred to as “new” BWP). Certain aspects, such as in example 800, use non-scheduling DL DCI format for both DL BWP and UL BWP switching.

Furthermore in the depicted example, the user equipment sends, to the network entity, a HARQ feedback 804, such as an ACK, for the DCI 802. In certain aspects, the DCI 802 is obtained, and the HARQ feedback 804 is sent, on the source BWP 806. In some aspects, a configured amount of time for a BWP switch (shown as BWP switching delay 810) starts after the HARQ feedback 804 is sent. In certain aspects, the user equipment stops monitoring or communicating on the source BWP 806 during the BWP switching delay 810. For example, the user equipment is not expected or required to receive or transmit data on the source BWP 806 during the BWP switching delay 810. In some aspects, the BWP switch occurs, for example by way of the target BWP 808 being activated, after the BWP switching delay 810. After the end of the BWP switching delay 810, the user equipment communicates with the network entity on the target BWP 808.

In certain aspects, when the source BWP 806 is on a primary cell of the user equipment, the HARQ feedback 804 is sent on the source BWP 806.

In some aspects, the BWP switch includes both a DL BWP switch and an UL BWP switch for TDD. For example, the BWP indicator in the DCI 802 does not indicate a separate UL BWP for TDD, because DL and UL BWPs with the same BWP ID are switched at the same time.

For FDD, additional information in the DL DCI format may include an indication of an UL target BWP. For example, the BWP indicator in the DCI 802 may further include an indication of another BWP (a second target BWP) for FDD, where the first target BWP described above as being indicated in the DCI 802 may be associated with the DL BWP switch and the second target BWP may be a target BWP of the UL BWP switch. As an example of indicating the target BWPs for the DL BWP switch and the UL BWP switch, the BWP indicator included in the DCI 802 may include a first BWP indicator associated with the DL BWP switch and a second BWP indicator associated with the UL BWP switch. For example, the DL DCI format may include two fields: a BWP indicator for DL and a BWP indicator for UL.

As another example of indicating the target BWPs for the DL BWP switch and the UL BWP switch, the BWP indicator included in the DCI 802 may include an indication of a pair of identifiers including a DL BWP identifier and an UL BWP identifier. For example, a joint BWP indicator field may indicate a pair of BWP IDs: a DL BWP ID and an UL BWP ID. In such examples, a value of the joint BWP indicator field may jointly indicate the pair of BWP IDs. In certain aspects, the mapping between values of the BWP indicator fields and corresponding pairs of BWP IDs may be configured by RRC signaling, which may be beneficial since not all combinations may be needed. As another example of indicating the target BWPs for the DL BWP switch and the UL BWP switch, the BWP indicator included in the DCI 802 may include a BWP identifier and a value indicating whether the BWP identifier is a DL BWP identifier or an UL BWP identifier. For example, a field (e.g., a configured or defined 1-bit field) in the DCI 802 may indicate whether the BWP indicator indicates a DL BWP ID or a UL BWP ID. For this example, the same DCI format can switch the DL BWP and the UL BWP at different instances, but not both of the DL BWP and the UL BWP at the same time. For any of the examples described above, the presence or interpretation/processing of one or more DCI fields as described above may be configured by RRC signaling to the user equipment (e.g., per DL DCI format), which may be beneficial since such ways of indicating the target BWPs for the DL BWP switch and the UL BWP switch may not be needed for TDD (e.g., in cases when DL BWP and UL BWP associated with the same BWP ID switch together). For example, such ways of indicating the target BWPs for the DL BWP switch may not be needed for TDD when DL BWP and UL BWP associated with the same BWP ID always switch together.

In certain aspects, the DCI 802 may include a cyclic redundancy check (CRC) scrambled by a cell radio network temporary identifier (C-RNTI) (for dynamic scheduling) or a configured scheduling radio network temporary identifier (CS-RNTI) (for a semi-persistent scheduling configuration) associated with the user equipment. For example, DCI format 1_1 or 1_2 may have no scheduling information for PDSCH, but may be associated with a HARQ-ACK, where C-RNTI or CS-RNTI may be used to scramble the CRC for the DCI. The CRC is used for error detection, where a failure to pass a CRC check after a decoding attempt would indicate a failure in decoding the DCI. The scrambling of the CRC by a radio network temporary identifier (RNTI) (e.g., C-RNTI or CS-RNTI) is used for indicating whether the DCI is intended for the user equipment receiving the DCI. As described above, the BWP indicator (corresponding to a “BWP indicator” field) included in the DCI 802 may include an indication of the target BWP ID, where the BWP switch may occur if the target BWP ID is different than the ID for a currently active BWP.

In some aspects, one or more fields of the DCI 802 may be set to “reserved” values to indicate that the DCI 802 does not schedule a PDSCH. For example, the DCI 802 may include one or more configured values (referred to as reserved values) indicative of (i) having no scheduling information for the PDSCH and (ii) a condition for triggering the BWP switch. In certain aspects, a user equipment may not detect a DCI that indicates a BWP ID other than the ID for a currently active BWP (where a BWP switch would not be allowed) if the one or more fields are not set to the reserved values.

In certain aspects, the one or more configured values for the one or more fields of the DCI 802 described above may be configured as part of at least one of: a frequency domain resource allocation (FDRA) field, a redundancy version (RV) field, a modulation and coding scheme (MCS) field, a new data indicator (NDI) field, or a time domain resource allocation (TDRA) field. For example, the FDRA field may be set to all 0's for resource allocation (RA) type 0, or to all 1's for RA type 1, or to all 0's for dynamic switch between RA type 0 and RA type 1. Resource allocation type indicates a method for resource allocation (e.g., in frequency domain), where RA type 0 refers to allocation of multiple groups of RBs indicated via a bitmap and RA type 1 refers to allocation of one or more consecutive RBs indicated via an indicator including an indication of a starting RB number and a length of the consecutive RBs. As another example, the RV field may be set to all 1's. As another example, the MCS field may be set to all 1's. As another example, the NDI field may be set to 0. As another example, the TDRA field may either be set to a reserved value (e.g., all 0's or all 1's) or indicate the time (a slot) for performing a BWP switch, where a user equipment is to switch to a target BWP (after the BWP switching delay 810).

Accordingly, these fields of the DCI 802 may function as an additional error check to avoid falsely detecting a perceived PDCCH (carrying DCI) that can result in an unwanted BWP switch, thereby reducing the likelihood of the network incorrectly assuming a successful BWP switch. Thus, certain aspects that use these fields of the DCI 802 in the manner described above reduce the occurrence of radio link failure and latency, and improve reliability.

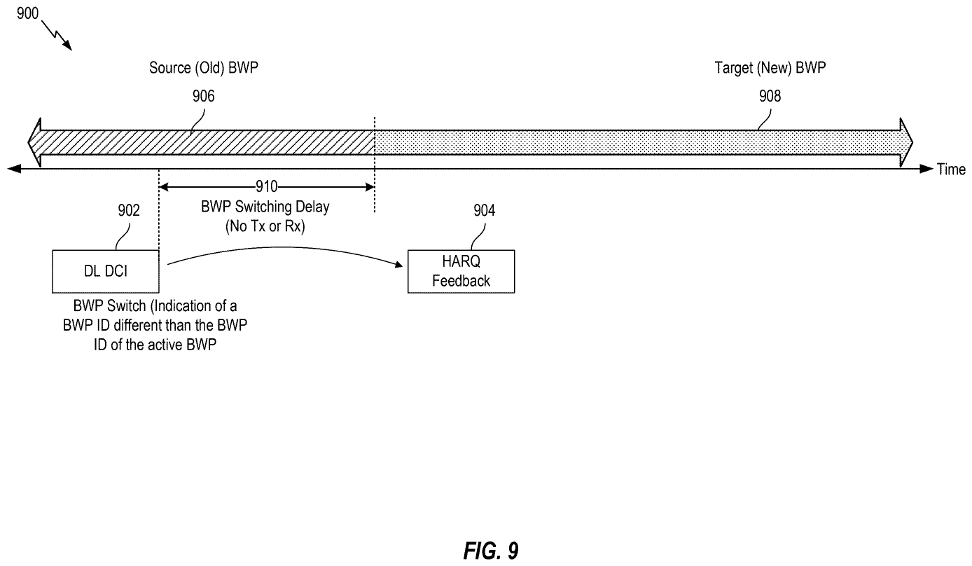

FIG. 9 depicts another example 900 of aligning a BWP between a user equipment and a network entity for a BWP switch. In the depicted example 900, a user equipment obtains, from a network entity, a DCI 902 including an indication of a BWP switch, for example, in accordance with a DL DCI format. For example, the indication of the BWP switch may include a BWP indicator. The BWP indicator may include an indication of a second BWP different than a first BWP, where the first BWP may be a currently active BWP. An example of an indication of a BWP may be an identifier such as a BWP ID. In the depicted example, the first BWP is source BWP 906 (which also may be referred to as “old” BWP), and the second BWP is target BWP 908 (which also may be referred to as “new” BWP). Furthermore, the user equipment sends, to the network entity, a HARQ feedback 904, such as an ACK, for the DCI 902. In certain aspects, the DCI 902 is obtained on the source BWP 906, and the HARQ feedback 904 is sent on the target BWP 908 (after a BWP switch after the BWP switching delay 910). In some aspects, a configured amount of time for a BWP switch (shown as BWP switching delay 910) starts after the DCI 902 is obtained. In certain aspects, the user equipment stops monitoring or communicating on the source BWP 906 during the BWP switching delay 910. For example, the user equipment is not expected (e.g., required) to receive or transmit data on the source BWP 906 during the BWP switching delay 910. In some aspects, the BWP switch occurs, for example by way of the target BWP 908 being activated, after the BWP switching delay 910. After the end of the BWP switching delay 910, the user equipment communicates with the network entity on the target BWP 908.

In certain aspects, the DCI 902 may include a CRC scrambled by a C-RNTI or a CS-RNTI associated with the user equipment. For example, DCI format 1_1 or 1_2 may have no scheduling information for PDSCH, but may be associated with a HARQ-ACK, where C-RNTI or CS-RNTI may be used to scramble the CRC for the DCI. As described above, the BWP indicator (corresponding to a “BWP indicator” field) included in the DCI 902 may include an indication of the target BWP ID, where the BWP switch may occur if the target BWP ID is different than the ID for a currently active BWP.

Certain aspects of the example 900 use a non-scheduling DL DCI format. In some aspects, one or more fields of the DCI 902 may be set to “reserved” values to indicate that the DCI 902 does not schedule a PDSCH. For example, the DCI 902 may include one or more configured values (referred to as reserved values) indicative of (i) having no scheduling information for the PDSCH and (ii) a condition for triggering the BWP switch. In certain aspects, a user equipment may not detect a DCI that indicates a BWP ID other than the ID for a currently active BWP (where a BWP switch would not be allowed) if the one or more fields are not set to the reserved values.

In certain aspects, the one or more configured values for the one or more fields of the DCI 902 described above may be configured as part of at least one of: an FDRA field, an RV field, an MCS field, an NDI field, or a TDRA field. For example, the FDRA field may be set to all 0's for RA type 0, or to all 1's for RA type 1, or to all 0's for dynamic switch between RA type 0 and RA type 1. As another example, the RV field may be set to all 1's. As another example, the MCS field may be set to all 1's. As another example, the NDI field may be set to 0. As another example, the TDRA field may either be set to a reserved value (e.g., all 0's or all 1's) or indicate the time (a slot) for performing a BWP switch, where a user equipment is to switch to a target BWP (after the BWP switching delay 910).

Accordingly, these fields of the DCI 902 may function as additional error check to avoid falsely detecting a perceived PDCCH (carrying DCI) that can result in an unwanted BWP switch, thereby reducing the likelihood of the network incorrectly assuming a successful BWP switch. Thus, certain aspects that use these fields of the DCI 902 in the manner described above reduce the occurrence of radio link failure and latency, and improve reliability.

Some aspects use non-scheduling DL DCI format for both DL BWP switch and UL BWP switch, where for FDD, certain information in the DL DCI format may include an indication of an UL target BWP. For example, the BWP indicator in the DCI 902 may include an indication of a second target BWP for FDD, where the first target BWP described above as being indicated in the DCI 902 may be associated with the DL BWP switch and the second target BWP may be a target BWP of the UL BWP switch. As an example of indicating the target BWPs for the DL BWP switch and the UL BWP switch, the BWP indicator included in the DCI 902 may include a first BWP indicator associated with the DL BWP switch and a second BWP indicator associated with the UL BWP switch. For example, the DL DCI format may include two fields: a BWP indicator for DL and a BWP indicator for UL.

As another example of indicating the target BWPs for the DL BWP switch and the UL BWP switch, the BWP indicator included in the DCI 902 may include an indication of a pair of identifiers including a DL BWP identifier and an UL BWP identifier. For example, a joint BWP indicator field may indicate a pair of BWP IDs: a DL BWP ID and an UL BWP ID. In such examples, a value of the joint BWP indicator field may jointly indicate the pair of BWP IDs. In certain aspects, the mapping between values of the BWP indicator fields and corresponding pairs of BWP IDs may be configured by RRC signaling, which may be beneficial since not all combinations may be needed. As another example of indicating the target BWPs for the DL BWP switch and the UL BWP switch, the BWP indicator included in the DCI 902 may include a BWP identifier and a value indicating whether the BWP identifier is a DL BWP identifier or an UL BWP identifier. For example, a field (e.g., a configured or defined 1-bit field) in the DCI 902 may indicate whether the BWP indicator indicates a DL BWP ID or a UL BWP ID. For this example, the same DCI format can switch the DL BWP and the UL BWP at different instances, but not both of the DL BWP and the UL BWP at the same time.

Referring back to the example 800 of FIG. 8, the latency of the BWP switch may be less for the example 900 of FIG. 9, compared to the example 800 of FIG. 8, since the BWP switching delay 910 starts after the DCI 902 is obtained, rather than after the HARQ feedback 904 is sent. On the other hand, an actual interruption in the communication between the user equipment and the network entity may be less for the example 800 of FIG. 8, compared to the example 900 of FIG. 9, since a DCI decoding time does not need to be part of the BWP switching delay 810 for the example 800 of FIG. 8.

### Example Signaling for Alignment of Bandwidth Part Between User Equipment and Network Entity

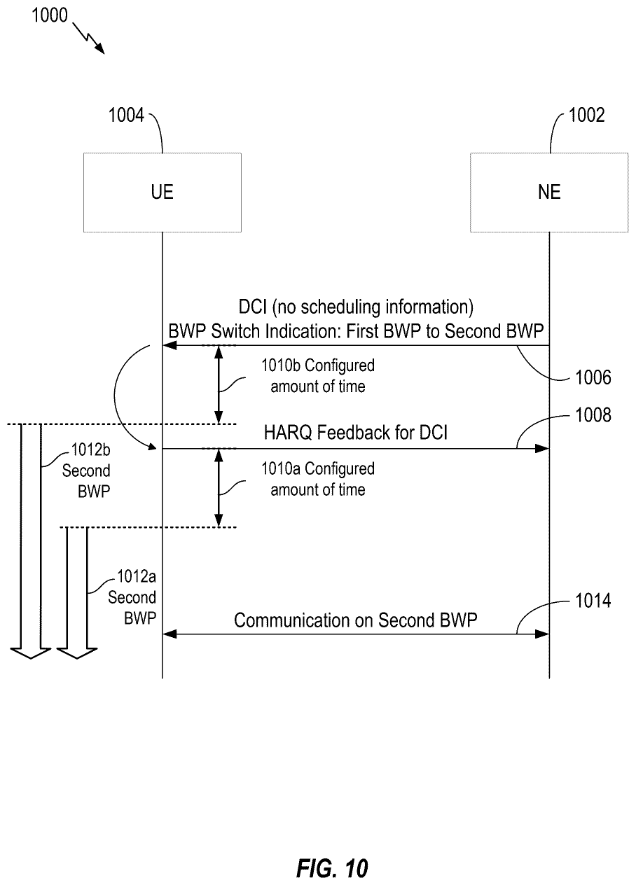

FIG. 10 depicts a process flow 1000 for communications in a network between a network entity (NE) 1002 and a UE 1004. In some aspects, the NE 1002 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1004 may be an example of UE 104 depicted and described with respect to FIG. 1 or the UE 304 depicted and described with respect to FIG. 3. However, in other aspects, UE 1004 may be another type of wireless communications device and NE 1002 may be another type of network entity or network node, such as those described herein.

At 1006, the UE 1004 obtains, from the NE 1002, a DCI including an indication of a BWP switch, where the indication of the BWP switch includes a BWP indicator. The BWP indicator includes an indication of a second BWP different than a first BWP, where the first BWP is a currently active BWP. In certain aspects, the DCI includes no scheduling information, for example, for a PDSCH. For example, the DCI obtained at 1006 may be similar to that described above with reference to DCI 802 of FIG. 8 and/or DCI 902 of FIG. 9.

At 1008, the UE 1004 sends, to the NE 1002, a HARQ feedback, such as an ACK, for example for the DCI. For example, the HARQ feedback sent at 1008 may be similar to that described above with reference to HARQ feedback 804 of FIG. 8 and/or HARQ feedback 904 of FIG. 9.

In certain aspects, a configured amount of time 1010a (a BWP switching delay) starts after the HARQ feedback is sent at 1008, as described herein with reference to FIG. 8. After the configured amount of time 1010a, second BWP 1012a is activated (switched).

In some aspects, a configured amount of time 1010b (a BWP switching delay) starts after the DCI is obtained at 1006, as described herein with reference to FIG. 9. After the configured amount of time 1010b, second BWP 1012b is activated (switched).

At 1014, the UE 1004 communicates with the NE 1002 on the second BWP (1012a, 1012b).

Note that the process flow 1000 illustrated in FIG. 10 is an example of aligning BWP between user equipment and network entity, and aspects of the present disclosure may be applied to such alignment of BWP between user equipment and network entity. Note that the process flow 1000 illustrated in FIG. 10 is described herein to facilitate an understanding of the alignment of BWP between user equipment and network entity, and aspects of the present disclosure may be performed in various manners via alternative or additional signaling and/or operations. In certain aspects, the operations and/or signaling of FIG. 10 may occur in an order different from that described or depicted, and various actions, operations, and/or signaling may be added, omitted, or combined.

### Additional Aspects Related to Alignment of Bandwidth Part Between User Equipment and Network Entity

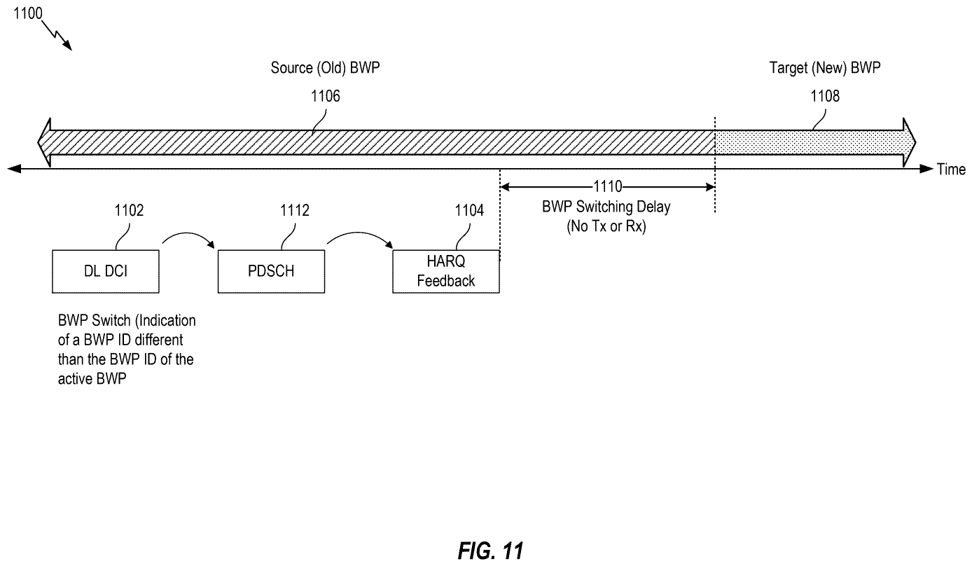

FIG. 11 depicts another example 1100 of aligning BWP between a user equipment and a network entity for a BWP switch. In the depicted example 1100, a user equipment obtains, from a network entity, a DCI 1102 including an indication of a BWP switch, for example, in accordance with a DL DCI format. For example, the indication of the BWP switch may include a BWP indicator. The BWP indicator may include an indication of a second BWP different than a first BWP, where the first BWP may be a currently active BWP. An example of an indication of a BWP may be an identifier such as a BWP ID. In the depicted example, the first BWP is source BWP 1106 (which also may be referred to as “old” BWP), and the second BWP is target BWP 1108 (which also may be referred to as “new” BWP).

In some aspects, the DCI 1102 includes scheduling information, for example, for a PDSCH such as PDSCH 1112. Accordingly, after obtaining the DCI 1102, the user equipment obtains, from the network entity, the PDSCH 1112 in accordance with the scheduling information. Furthermore, the user equipment sends, to the network entity, a HARQ feedback 1104, such as an ACK, for the PDSCH 1112. In certain aspects, a configured amount of time for a BWP switch (shown as BWP switching delay 1110) starts after the HARQ feedback 1104 is sent. Accordingly, the BWP switch occurs if the PDSCH is correctly decoded, resulting in the HARQ feedback 1104 for the PDSCH 1112 being sent, for example, as a positive acknowledgment (ACK). For example, the BWP switch may not occur if only the DCI 1102 (that schedules the PDSCH 1112) is decoded correctly but not the PDSCH 1112 itself. In some aspects, the user equipment stops monitoring or communicating on the source BWP 1106 during the BWP switching delay 1110. For example, the user equipment is not expected (e.g., required) to receive or transmit data on the source BWP 1106 during the BWP switching delay 1110. In certain aspects, the BWP switch occurs, for example by way of the target BWP 1108 being activated, after the BWP switching delay 1110.

After the end of the BWP switching delay 1110, the user equipment communicates with the network entity on the target BWP 1108. In some aspects, the DCI 1102 and the PDSCH 1112 are obtained, and the HARQ feedback 1104 is sent, on the source BWP 1106. By switching the target BWP 1108 after sending the HARQ feedback 1104 acknowledging the reception of the PDSCH 1112 (and hence acknowledging the reception of the DCI 1102), the user equipment and the network entity can be aligned on when the BWP switch occurs based on a common understanding of whether the scheduling DCI (the DCI 1102) and the scheduled PDSCH (the PDSCH 1112) are successfully received and decoded, thereby reducing the occurrence of radio link failure and latency, and improving reliability.

Certain aspects use non-scheduling DL DCI format for both DL BWP switch and UL BWP switch. Regardless of whether scheduling information is included in the DCI 1102 or not, for FDD, certain information in the DL DCI format may include an indication of an UL target BWP. For example, the BWP indicator in the DCI 1102 may include an indication of a second target BWP for FDD, where the first target BWP described above as being indicated in the DCI 1102 may be associated with the DL BWP switch and the second target BWP may be a target BWP of the UL BWP switch. As an example of indicating the target BWPs for the DL BWP switch and the UL BWP switch, the BWP indicator included in the DCI 1102 may include a first BWP indicator associated with the DL BWP switch and a second BWP indicator associated with the UL BWP switch. For example, the DL DCI format may include two fields: a BWP indicator for DL and a BWP indicator for UL. As another example of indicating the target BWPs for the DL BWP switch and the UL BWP switch, the BWP indicator included in the DCI 1102 may include an indication of a pair of identifiers including a DL BWP identifier and an UL BWP identifier. For example, a joint BWP indicator field may indicate a pair of BWP IDs: a DL BWP ID and an UL BWP ID. In such examples, a value of the joint BWP indicator field may jointly indicate the pair of BWP IDs. In certain aspects, the mapping between values of the BWP indicator fields and corresponding pairs of BWP IDs may be configured by RRC signaling, which may be beneficial since not all combinations may be needed. As another example of indicating the target BWPs for the DL BWP switch and the UL BWP switch, the BWP indicator included in the DCI 1102 may include a BWP identifier and a value indicating whether the BWP identifier is a DL BWP identifier or an UL BWP identifier. For example, a field (e.g., a configured or defined 1-bit field) in the DCI 1102 may indicate whether the BWP indicator indicates a DL BWP ID or a UL BWP ID. For this example, the same DCI format can switch the DL BWP and the UL BWP at different instances, but not both of the DL BWP and the UL BWP at the same time.

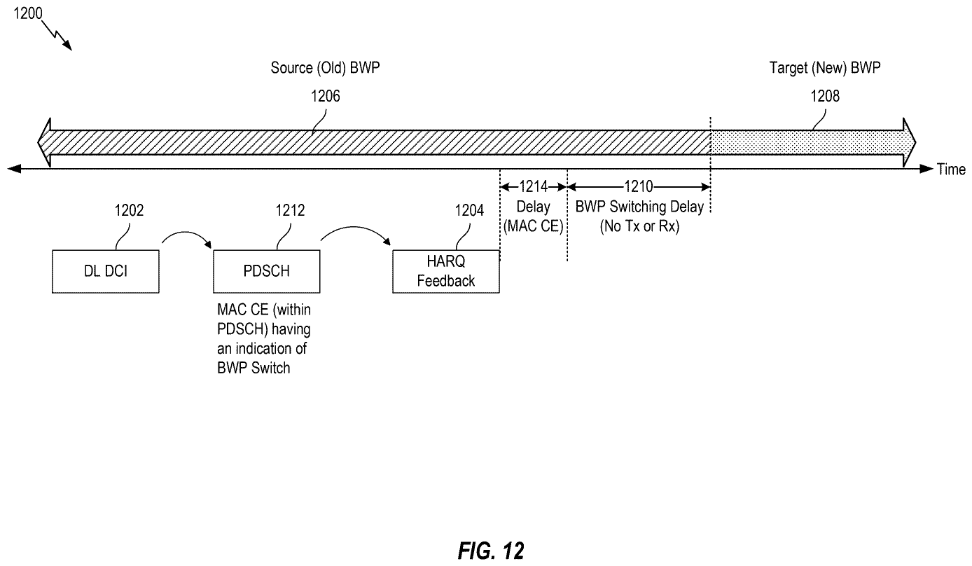

FIG. 12 depicts another example 1200 of aligning BWP between a user equipment and a network entity for a BWP switch. In the depicted example 1200, a user equipment obtains, from a network entity, a DCI 1202 in accordance with a DL DCI format. In certain aspects, the DCI 1202 includes scheduling information for a PDSCH 1212. In some aspects, the user equipment obtains, from the network entity, the PDSCH 1212 in accordance with the scheduling information included in the DCI 1202. In certain aspects, the PDSCH 1212 includes a MAC control element (CE), where the MAC CE includes an indication of a BWP switch. For example, the indication of the BWP switch may include a BWP indicator. The BWP indicator may include an indication of a second BWP different than a first BWP, where the first BWP may be a currently active BWP. An example of an indication of a BWP may be an identifier such as a BWP ID. In the depicted example, the first BWP is source BWP 1206 (which also may be referred to as “old” BWP), and the second BWP is target BWP 1208 (which also may be referred to as “new” BWP).

Furthermore, the user equipment sends, to the network entity, a HARQ feedback 1204, such as an ACK, for the PDSCH 1212. In certain aspects, a configured amount of time for a BWP switch (shown as BWP switching delay 1210) starts after the HARQ feedback 1204 is sent and the MAC CE is parsed and decoded. Accordingly, the BWP switching delay 1210 starts after a second configured amount of time (delay 1214 associated with the MAC CE, such as for processing the MAC CE) after the HARQ feedback 1204 is sent. In some aspects, the user equipment stops monitoring or communicating on the source BWP 1206 during the BWP switching delay 1210. For example, the user equipment is not expected (e.g., required) to receive or transmit data on the source BWP 1206 during the BWP switching delay 1210. In certain aspects, the BWP switch occurs, for example by way of the target BWP 1208 being activated, after the BWP switching delay 1210. After the end of the BWP switching delay 1210, the user equipment communicates with the network entity on the target BWP 1208. In some aspects, the DCI 1202 and the PDSCH 1212 are obtained, and the HARQ feedback 1204 is sent, on the source BWP 1206. By switching the target BWP 1208 after sending the HARQ feedback 1204, the user equipment and the network entity can be aligned on when the BWP switch occurs based on a common understanding of whether the scheduling DCI (the DCI 1202) and the scheduled PDSCH (the PDSCH 1212) were successfully received and decoded, thereby reducing the occurrence of radio link failure and latency, and improving reliability.

In certain aspects, the MAC CE parsing results in the delay 1214, which may be, for example, 3 ms, after which the BWP switching delay 1210 starts.

In some aspects, the MAC CE may include an indication of a DL target BWP. In some aspects, the MAC CE may include an indication of an UL target BWP. In some aspects, the MAC CE may include an indication of DL and UL target BWPs (separately).

In certain aspects, the MAC CE may include at least one of: an applicable serving cell index, one or more of a downlink target BWP identifier or an uplink target BWP identifier, or one or more parameter updates. For example, one or more parameters (of a BWP) corresponding to the one or more parameter updates may initially be configured by RRC signaling. These parameters of a BWP, while still configurable by RRC signaling, may be updated by the MAC CE. In some aspects, a fixed-length MAC CE or a variable-length MAC CE (e.g., where BWP switching for multiple carriers can be indicated by the same MAC CE) can be used.

In certain aspects of the example 1200, because the MAC CE included in the PDSCH 1212 (e.g., not being limited to having a small or fixed size) can be used not only for indicating a BWP switch but also for other parameters updates, such as for indicating BWP switching for multiple carriers, the associated latency may be reduced.

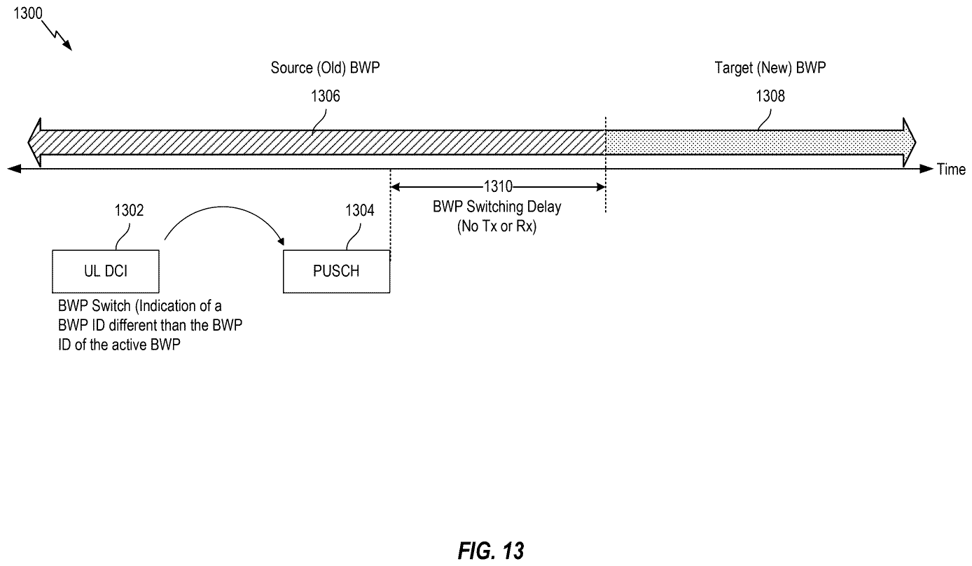

FIG. 13 depicts another example 1300 of aligning BWP between a user equipment and a network entity for a BWP switch. In the depicted example 1300, a user equipment obtains, from a network entity, a DCI 1302 including an indication of a BWP switch, for example, in accordance with an UL DCI format (DCI format 0_1/0_2). For example, the indication of the BWP switch may include a BWP indicator. The BWP indicator may include an indication of a second BWP different than a first BWP, where the first BWP may be a currently active BWP. An example of an indication of a BWP may be an identifier such as a BWP ID. In the depicted example, the first BWP is source BWP 1306 (which also may be referred to as “old” BWP), and the second BWP is target BWP 1308 (which also may be referred to as “new” BWP).

In some aspects, the DCI 1302 includes scheduling information, for example, for a PUSCH such as PUSCH 1304. Accordingly, after obtaining the DCI 1302, the user equipment sends, to the network entity, the PUSCH 1304 in accordance with the scheduling information. In certain aspects, a configured amount of time for a BWP switch (shown as BWP switching delay 1310) starts after the PUSCH 1304 is sent. Accordingly, the BWP switch occurs if the DCI 1302 is correctly decoded, resulting in the PUSCH 1304 being sent. In some aspects, the user equipment stops monitoring or communicating on the source BWP 1306 during the BWP switching delay 1310. For example, the user equipment is not expected (e.g., required) to receive or transmit data on the source BWP 1306 during the BWP switching delay 1310. In certain aspects, the BWP switch occurs, for example by way of the target BWP 1308 being activated, after the BWP switching delay 1310. After the end of the BWP switching delay 1310, the user equipment communicates with the network entity on the target BWP 1308. In some aspects, the DCI 1302 is obtained, and the PUSCH 1304 is sent, on the source BWP 1306.

In certain aspects, the example 1300 may be an alternative solution, or an additional solution, to the example 800 of FIG. 8 and/or the example 1100 of FIG. 11.

In certain aspects, the DCI 1302 may include an indication of both a DL BWP switch and an UL BWP switch (for FDD). For example, additional information in the UL DCI format may include an indication of a DL target BWP. For example, the BWP indicator in the DCI 1302 may further include an indication of another BWP (a second target BWP) for FDD, where the first target BWP described above as being indicated in the DCI 1302 may be associated with the UL BWP switch and the second target BWP may be a target BWP of the DL BWP switch. As an example of indicating the target BWPs for the DL BWP switch and the UL BWP switch, the BWP indicator included in the DCI 1302 may include a first BWP indicator associated with the UL BWP switch and a second BWP indicator associated with the DL BWP switch. For example, the UL DCI format may include two fields: a BWP indicator for UL and a BWP indicator for DL.

As another example of indicating the target BWPs for the DL BWP switch and the UL BWP switch, the BWP indicator included in the DCI 1302 may include an indication of a pair of identifiers including a DL BWP identifier and an UL BWP identifier. For example, a joint BWP indicator field may indicate a pair of BWP IDs: a DL BWP ID and an UL BWP ID. In such examples, a value of the joint BWP indicator field may jointly indicate the pair of BWP IDs. In certain aspects, the mapping between values of the BWP indicator fields and corresponding pairs of BWP IDs may be configured by RRC signaling, which may be beneficial since not all combinations may be needed.

As another example of indicating the target BWPs for the DL BWP switch and the UL BWP switch, the BWP indicator included in the DCI 1302 may include a BWP identifier and a value indicating whether the BWP identifier is a DL BWP identifier or an UL BWP identifier. For example, a field (e.g., a configured or defined 1-bit field) in the DCI 1302 may indicate whether the BWP indicator indicates a DL BWP ID or a UL BWP ID. For this example, the same DCI format can switch the DL BWP and the UL BWP at different instances, but not both of the DL BWP and the UL BWP at the same time.

For any of the examples described above, the presence or interpretation/processing of one or more DCI fields as described above may be configured by RRC signaling to the user equipment (e.g., per UL DCI format), which may be beneficial since such ways of indicating the target BWPs for the DL BWP switch and the UL BWP switch may not be needed for TDD.

In some aspects, the DCI 1302 includes an indication of an UL target BWP (e.g., an UL target BWP ID), while the DCI 802, 1102 of the examples 800 and 1100 includes an indication of a DL target BWP (e.g., a DL target BWP ID).

By switching the target BWP 1308 after sending the PUSCH 1304, the user equipment and the network entity can be aligned on when the BWP switch occurs based on a common understanding of whether the scheduling DCI (the DCI 1302) is successfully received and decoded, thereby reducing the occurrence of radio link failure and latency, and improving reliability.

With respect to the example 800 of FIG. 8, the example 1100 of FIG. 11, and the example 1300 of FIG. 13, in certain aspects, the user equipment may stop monitoring for any additional DCI on, respectively, the source BWP 806, 1106, or 1306 after obtaining a DCI including an indication of a BWP switch (DCI 802, 1102, 1302) and before a subsequent UL transmission (e.g., HARQ feedback or PUSCH). For example, the user equipment may stop monitoring for any additional DCI with scheduling information for DL or UL transmissions on the source BWP 806, 1106, or 1306 between the DCI including an indication of a BWP switch being obtained and the completion of the BWP switch (e.g., including the BWP switching delay after the subsequent UL transmission, which is responsive to the DCI). In some aspects, the restriction on the monitoring described above may be applicable if the scheduled DL or UL transmission in the additional DCI is in the target BWP (after the completion of the BWP switch).

Having a restriction on the monitoring as described above can have one or more of the following technical benefits. First, there would be no ambiguity in DCI size and interpretation. If there is a DCI scheduling PDSCH or PUSCH in the target BWP during the time described above, the interpretation of DCI fields may be complicated (where the DCI size may be based on the source BWP while the interpretation of DCI fields may be based on the target BWP). Second, there may be less burden on user equipment implementation, where there would be no need to monitor DCI on the source BWP before the completion of a BWP switch.

### Example Operations

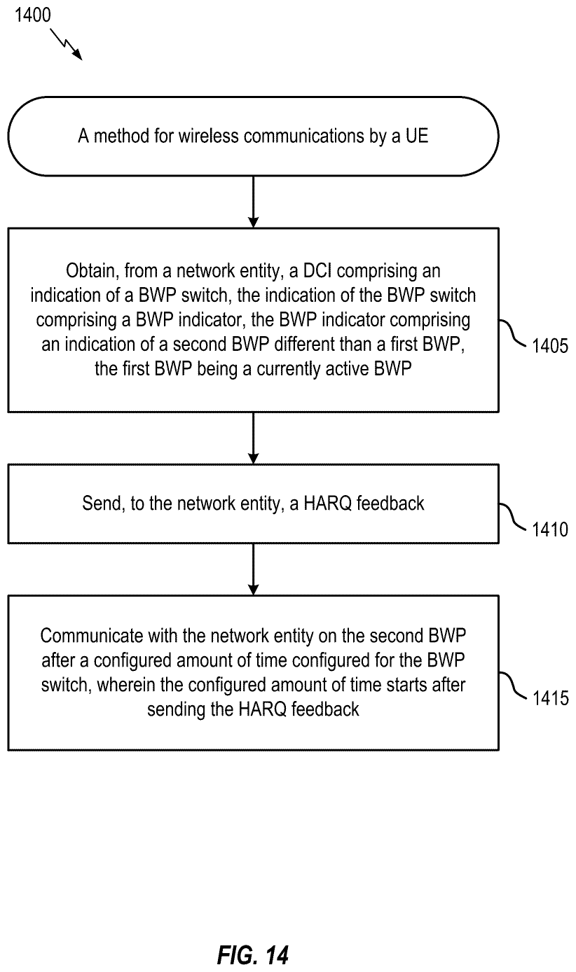

FIG. 14 shows a method 1400 for wireless communications by an apparatus, such as UE 104 of FIG. 1 or UE 304 of FIG. 3.

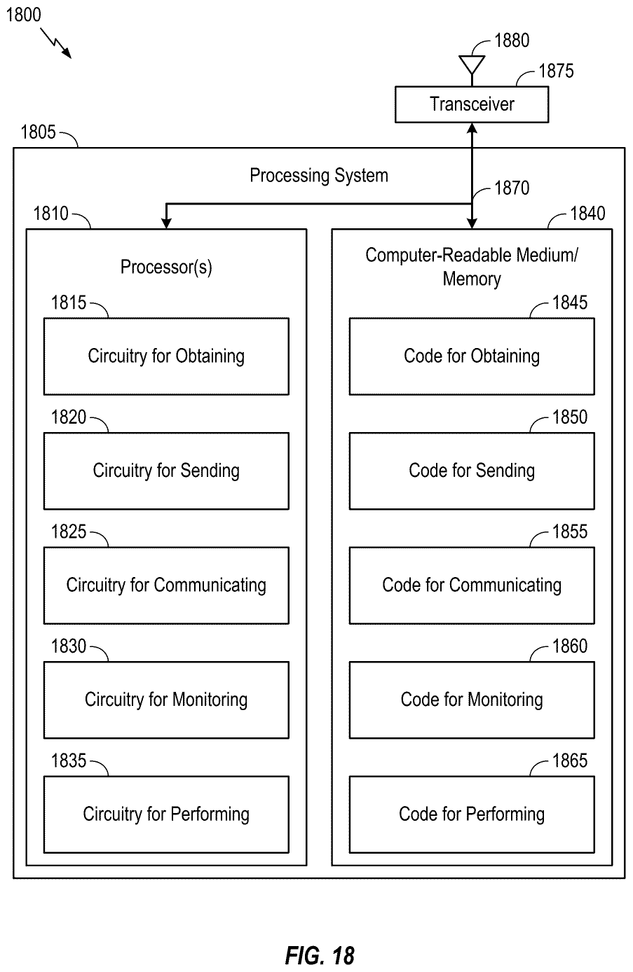

Method 1400 begins at block 1405 with obtaining, from a network entity, a DCI comprising an indication of a BWP switch, the indication of the BWP switch comprising a BWP indicator, the BWP indicator comprising an indication of a second BWP different than a first BWP, the first BWP being a currently active BWP. For example, communications device 1800 of FIG. 18 may perform the operations at block 1405 using one or more components, such as transceiver 1875 (and antenna 1880), one or more processors 1810, and/or computer-readable medium/memory 1840. The operations at block 1405 may be performed in a manner similar to that described above at 1006 of FIG. 10. In certain aspects, the DCI and obtaining of the DCI at block 1405 may be similar to the DCI 802 and the obtaining of the DCI 802 described herein with reference to FIG. 8, and/or the DCI 1102 and the obtaining of the DCI 1102 described herein with reference to FIG. 11.

Method 1400 then proceeds to block 1410 with sending, to the network entity, a HARQ feedback. For example, communications device 1800 of FIG. 18 may perform the operations at block 1410 using one or more components, such as transceiver 1875 (and antenna 1880), one or more processors 1810, and/or computer-readable medium/memory 1840. The operations at block 1410 may be performed in a manner similar to that described above at 1008 of FIG. 10. In certain aspects, the HARQ feedback and the sending of the HARQ feedback at block 1410 may be similar to the HARQ feedback 804 and the sending of the HARQ feedback 804 described herein with reference to FIG. 8, and/or the HARQ feedback 1104 and the sending of the HARQ feedback 1104 described herein with reference to FIG. 11.

Method 1400 then proceeds to block 1415 with communicating with the network entity on the second BWP after a configured amount of time configured for the BWP switch, where the configured amount of time starts after sending the HARQ feedback. For example, communications device 1800 of FIG. 18 may perform the operations at block 1415 using one or more components, such as transceiver 1875 (and antenna 1880), one or more processors 1810, and/or computer-readable medium/memory 1840. The operations at block 1415 may be performed in a manner similar to a portion of that described above at 1014 of FIG. 10 with reference to the configured amount of time 1010a and the second BWP 1012a. In certain aspects, the second BWP and the configured amount of time at block 1415 may be similar to, respectively, the target BWP 808 and the BWP switching delay 810 described herein with reference to FIG. 8, and/or the target BWP 1108 and the BWP switching delay 1110 described herein with reference to FIG. 11.

In some aspects, the DCI includes a downlink DCI format with no scheduling information for a PDSCH (e.g., similar to DCI 802 of FIG. 8).

In some aspects, method 1400 further includes stopping monitoring or communicating on the first BWP during the configured amount of time (e.g., as similarly described above with reference to the BWP switching delay 810 of FIG. 8, and/or the BWP switching delay 1110 of FIG. 11).

In some aspects, block 1410 includes sending the HARQ feedback on the first BWP when the first BWP is on a primary cell of the user equipment.

In some aspects, the BWP switch includes both a downlink BWP switch and an uplink BWP switch for TDD.

In some aspects, the BWP indicator further includes an indication of a third BWP for FDD, wherein the second BWP is associated with a downlink BWP switch and the third BWP is a target BWP of an uplink BWP switch.

In some aspects, the BWP indicator includes a first BWP indicator associated with the downlink BWP switch and a second BWP indicator associated with the uplink BWP switch.

In some aspects, the BWP indicator includes an indication of a pair of identifiers comprising a downlink BWP identifier and an uplink BWP identifier.

In some aspects, the BWP indicator includes a BWP identifier and a value indicating whether the BWP identifier is a downlink BWP identifier or an uplink BWP identifier.

In some aspects, the DCI includes a CRC scrambled by a C-RNTI or a CS-RNTI associated with the user equipment.

In some aspects, the DCI includes one or more configured values indicative of (i) having no scheduling information for the PDSCH and (ii) a condition for triggering the BWP switch.

In some aspects, the one or more configured values are configured as part of at least one of: a FDRA field, a RV field, a MCS field, an NDI field, or a TDRA field.

In some aspects, at least one configured value of the one or more configured values indicates a slot for performing the BWP switch.

In some aspects, the DCI includes a downlink DCI format with scheduling information for a PDSCH, where the method 1400 further includes performing the BWP switch based on the PDSCH being successfully decoded, where the HARQ feedback includes an ACK for the PDSCH.

In some aspects, method 1400, or any aspect related to it, may be performed by an apparatus, such as communications device 1800 of FIG. 18, which includes various components operable, configured, or adapted to perform the method 1400. Communications device 1800 is described below in further detail.

By switching between BWPs based on a HARQ feedback such as an ACK associated with the DCI that carries the BWP switch indication, an OOS status regarding BWP between user equipment and network entity is avoided since the ACK indicates that the DCI was successfully received, reducing the likelihood of the network incorrectly assuming a successful BWP switch. This reduces the occurrence of radio link failure and latency, and improves reliability. Similarly, switching between BWPs based on an ACK associated with the PDSCH scheduled by a scheduling DCI (and applying the BWP switching delay after the ACK) achieves a common understanding of whether the scheduling DCI was successfully received and decoded, thereby reducing the occurrence of radio link failure and latency, and improving reliability.

Note that FIG. 14 is just one example of a method, and other methods including fewer, additional, or alternative operations are possible consistent with this disclosure.

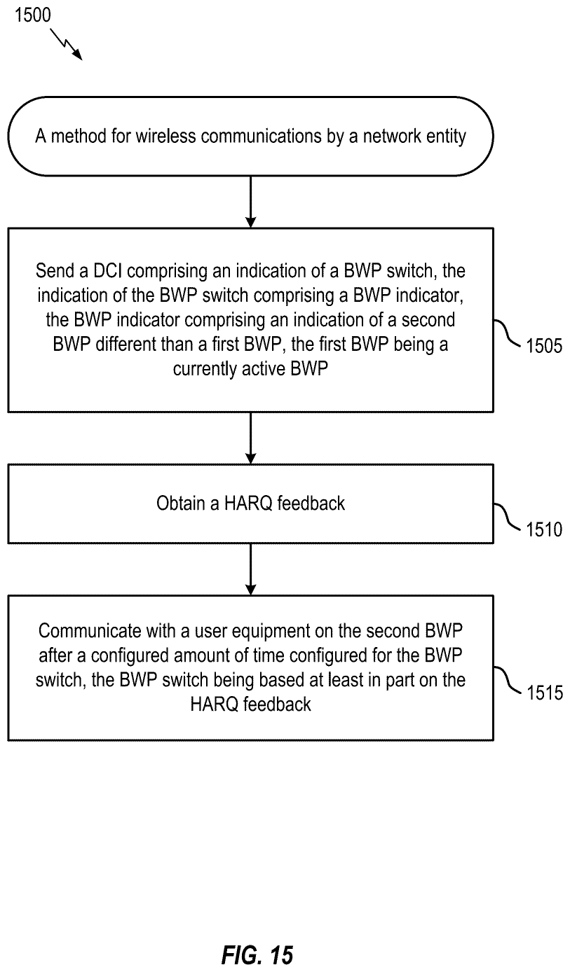

FIG. 15 shows a method 1500 for wireless communications by an apparatus, such as BS 102 of FIG. 1, a first network entity 300 or second network entity 302 of FIG. 3, or a disaggregated base station as discussed with respect to FIG. 2.

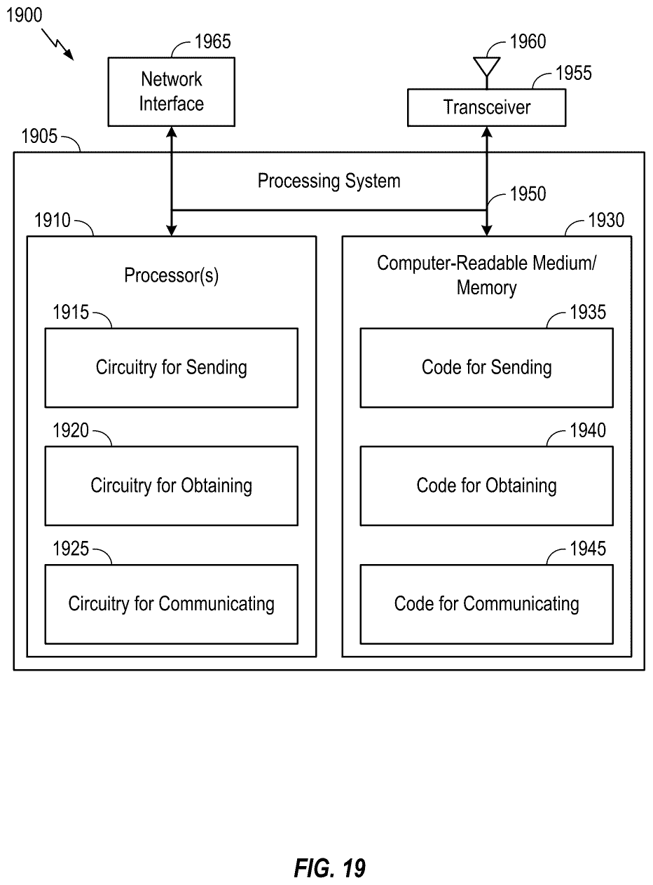

Method 1500 begins at block 1505 with sending a DCI comprising an indication of a BWP switch, the indication of the BWP switch comprising a BWP indicator, the BWP indicator comprising an indication of a second BWP different than a first BWP, the first BWP being a currently active BWP. For example, communications device 1900 of FIG. 19 may perform the operations at block 1505 using one or more components, such as transceiver 1955 (and antenna 1960), one or more processors 1910, and/or computer-readable medium/memory 1930. The operations at block 1505 may be performed in a manner similar to that described above at 1006 of FIG. 10. In certain aspects, the DCI at block 1505 may be similar to the DCI 802 described herein with reference to FIG. 8, and/or the DCI 1102 described herein with reference to FIG. 11.

Method 1500 then proceeds to block 1510 with obtaining a HARQ feedback. For example, communications device 1900 of FIG. 19 may perform the operations at block 1510 using one or more components, such as transceiver 1955 (and antenna 1960), one or more processors 1910, and/or computer-readable medium/memory 1930. The operations at block 1510 may be performed in a manner similar to that described above at 1008 of FIG. 10. In certain aspects, the HARQ feedback at block 1510 may be similar to the HARQ feedback 804 described herein with reference to FIG. 8, and/or the HARQ feedback 1104 described herein with reference to FIG. 11.

Method 1500 then proceeds to block 1515 with communicating with a user equipment on the second BWP after a configured amount of time configured for the BWP switch, the BWP switch being based at least in part on the HARQ feedback. For example, communications device 1900 of FIG. 19 may perform the operations at block 1515 using one or more components, such as transceiver 1955 (and antenna 1960), one or more processors 1910, and/or computer-readable medium/memory 1930. The operations at block 1515 may be performed in a manner similar to that described above at 1014 of FIG. 10. In certain aspects, the second BWP and the configured amount of time at block 1515 may be similar to, respectively, the target BWP 808 and the BWP switching delay 810 described herein with reference to FIG. 8, and/or the target BWP 1108 and the BWP switching delay 1110 described herein with reference to FIG. 11.

In some aspects, the DCI includes a downlink DCI format with no scheduling information for a PDSCH (e.g., similar to DCI 802 of FIG. 8).

In some aspects, the DCI includes a downlink DCI format with scheduling information for a PDSCH (e.g., similar to DCI 1102 of FIG. 11).

In some aspects, method 1500, or any aspect related to it, may be performed by an apparatus, such as communications device 1900 of FIG. 19, which includes various components operable, configured, or adapted to perform the method 1500. Communications device 1900 is described below in further detail.

As noted similarly for the method 1400 of FIG. 14, by switching between BWPs based on a HARQ feedback such as an ACK associated with the DCI that carries the BWP switch indication, an OOS status regarding BWP between user equipment and network entity is avoided since the ACK indicates that the DCI was successfully received, reducing the likelihood of the network incorrectly assuming a successful BWP switch. This reduces the occurrence of radio link failure and latency, and improves reliability. Moreover, switching between BWPs based on an ACK associated with the PDSCH scheduled by a scheduling DCI (and applying the BWP switching delay after the ACK) achieves a common understanding of whether the scheduling DCI was successfully received and decoded, thereby reducing the occurrence of radio link failure and latency, and improving reliability.

Note that FIG. 15 is just one example of a method, and other methods including fewer, additional, or alternative operations are possible consistent with this disclosure.

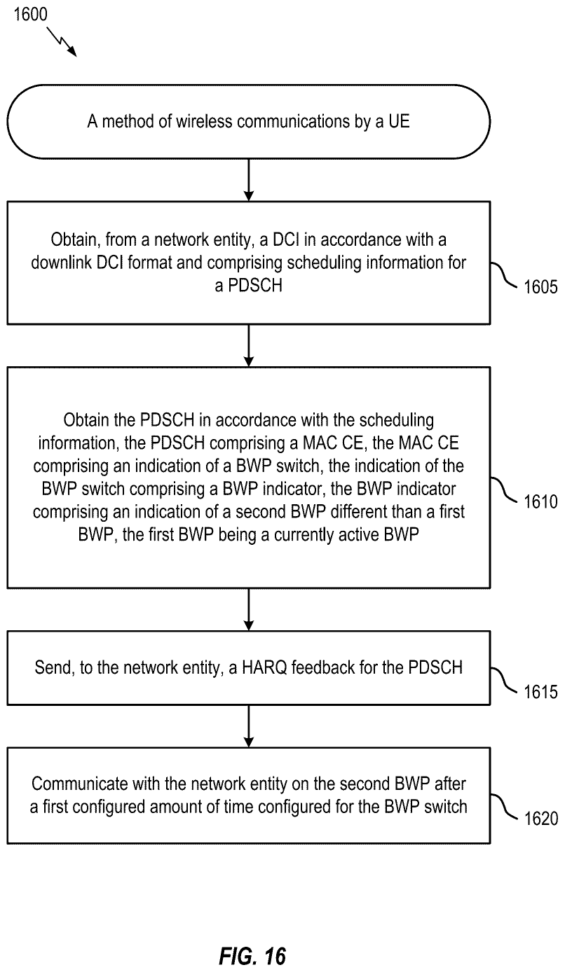

FIG. 16 shows a method 1600 for wireless communications by a user equipment, such as UE 104 of FIG. 1 or UE 304 of FIG. 3.

Method 1600 begins at block 1605 with obtaining, from a network entity, a DCI in accordance with a downlink DCI format and comprising scheduling information for a PDSCH. For example, communications device 1800 of FIG. 18 may perform the operations at block 1605 using one or more components, such as transceiver 1875 (and antenna 1880), one or more processors 1810, and/or computer-readable medium/memory 1840. The operations at block 1605 may be performed in a manner similar to that described above with reference to DCI 1202 of FIG. 12.

Method 1600 then proceeds to block 1610 with obtaining the PDSCH in accordance with the scheduling information, the PDSCH comprising a MAC CE, the MAC CE comprising an indication of a BWP switch, the indication of the BWP switch comprising a BWP indicator, the BWP indicator comprising an indication of a second BWP different than a first BWP, the first BWP being a currently active BWP. For example, communications device 1800 of FIG. 18 may perform the operations at block 1610 using one or more components, such as transceiver 1875 (and antenna 1880), one or more processors 1810, and/or computer-readable medium/memory 1840. The operations at block 1610 may be performed in a manner similar to that described above with reference to PDSCH 1212 of FIG. 12.

Method 1600 then proceeds to block 1615 with sending, to the network entity, a HARQ feedback for the PDSCH. For example, communications device 1800 of FIG. 18 may perform the operations at block 1615 using one or more components, such as transceiver 1875 (and antenna 1880), one or more processors 1810, and/or computer-readable medium/memory 1840. The operations at block 1615 may be performed in a manner similar to that described above with reference to HARQ feedback 1204 of FIG. 12.

Method 1600 then proceeds to block 1620 with communicating with the network entity on the second BWP after a first configured amount of time configured for the BWP switch. For example, communications device 1800 of FIG. 18 may perform the operations at block 1620 using one or more components, such as transceiver 1875 (and antenna 1880), one or more processors 1810, and/or computer-readable medium/memory 1840. The operations at block 1620 may be performed in a manner similar to that described above with reference to BWP switching delay 1210 and target BWP 1208 of FIG. 12.

In some aspects, the first configured amount of time begins after a second amount of time after sending the HARQ feedback, the second amount of time associated with the MAC CE (where the second amount of time associated with the MAC CE may be similar to delay 1214 of FIG. 12).

In some aspects, the MAC CE comprises, for a FDD cell, an indication of one of: a downlink target BWP; an uplink target BWP; or the downlink target BWP and the uplink target BWP.

In some aspects, the MAC CE comprises at least one of: an applicable serving cell index; one or more of a downlink target BWP identifier or an uplink target BWP identifier; or one or more parameter updates.

In some aspect, method 1600, or any aspect related to it, may be performed by an apparatus, such as communications device 1800 of FIG. 18, which includes various components operable, configured, or adapted to perform the method 1600. Communications device 1800 is described below in further detail.

As similarly noted for the example 1200 of FIG. 12, because the MAC CE included in the PDSCH for the method 1600 (corresponding to the MAC CE included in the PDSCH 1212 of FIG. 12) can be used not only for indicating a BWP switch but also for other parameters updates, such as for indicating BWP switching for multiple carriers, the associated latency may be reduced.

Note that FIG. 16 is just one example of a method, and other methods including fewer, additional, or alternative operations are possible consistent with this disclosure.

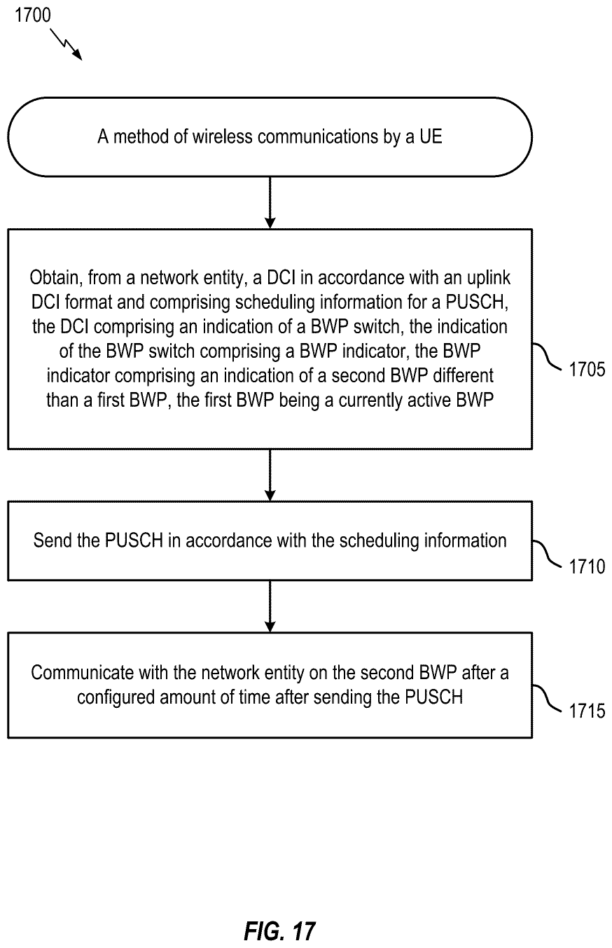

FIG. 17 shows a method 1700 for wireless communications by a user equipment, such as UE 104 of FIG. 1 or UE 304 of FIG. 3.

Method 1700 begins at block 1705 with obtaining, from a network entity, a DCI in accordance with an uplink DCI format and comprising scheduling information for a PUSCH, the DCI comprising an indication of a BWP switch, the indication of the BWP switch comprising a BWP indicator, the BWP indicator comprising an indication of a second BWP different than a first BWP, the first BWP being a currently active BWP. For example, communications device 1800 of FIG. 18 may perform the operations at block 1705 using one or more components, such as transceiver 1875 (and antenna 1880), one or more processors 1810, and/or computer-readable medium/memory 1840. The operations at block 1705 may be performed in a manner similar to that described above with reference to DCI 1302 of FIG. 13.

Method 1700 then proceeds to block 1710 with sending the PUSCH in accordance with the scheduling information. For example, communications device 1800 of FIG. 18 may perform the operations at block 1710 using one or more components, such as transceiver 1875 (and antenna 1880), one or more processors 1810, and/or computer-readable medium/memory 1840. The operations at block 1710 may be performed in a manner similar to that described above with reference to PUSCH 1304 of FIG. 13.

Method 1700 then proceeds to block 1715 with communicating with the network entity on the second BWP after a configured amount of time after sending the PUSCH. For example, communications device 1800 of FIG. 18 may perform the operations at block 1715 using one or more components, such as transceiver 1875 (and antenna 1880), one or more processors 1810, and/or computer-readable medium/memory 1840. The operations at block 1715 may be performed in a manner similar to that described above with reference to BWP switching delay 1310 and target BWP 1308 of FIG. 13.

In some aspect, method 1700, or any aspect related to it, may be performed by an apparatus, such as communications device 1800 of FIG. 18, which includes various components operable, configured, or adapted to perform the method 1700. Communications device 1800 is described below in further detail.

As similarly noted for the example 1300 of FIG. 13, by switching the target BWP after sending the PUSCH, the user equipment and the network entity can be aligned on when the BWP switch occurs based on a common understanding of whether the scheduling DCI (e.g., corresponding to the DCI 1302 of FIG. 13) is successfully received and decoded, thereby reducing the occurrence of radio link failure and latency, and improving reliability.

Note that FIG. 17 is just one example of a method, and other methods including fewer, additional, or alternative operations are possible consistent with this disclosure.

### Example Communications Devices

FIG. 18 depicts aspects of an example communications device 1800 configured for wireless communications. In some aspects, communications device 1800 is a user equipment, such as UE 104 described above with respect to FIG. 1 or UE 304 described with respect to FIG. 3.

The communications device 1800 includes a processing system 1805 coupled to a transceiver 1875 (e.g., a transmitter and/or a receiver). The transceiver 1875 is configured to transmit and receive signals for the communications device 1800 via an antenna 1880, such as the various signals as described herein. The processing system 1805 may be configured to perform processing functions for the communications device 1800, including processing signals received and/or to be transmitted by the communications device 1800.

The processing system 1805 includes one or more processors 1810 and a computer-readable medium/memory 1840. In various aspects, the one or more processors 1810 may be representative of the one or more processors 318 described with respect to FIG. 3. The one or more processors 1810 are coupled to a computer-readable medium/memory 1840 via a bus 1870. In some aspects, the computer-readable medium/memory 1840 may be representative of the one or more memories 320 described with respect to FIG. 3. The computer-readable medium/memory 1840 is a non-transitory computer-readable medium/memory. In certain aspects, the computer-readable medium/memory 1840 is configured to store instructions (e.g., computer-executable code), that when executed by the one or more processors 1810, cause the one or more processors 1810 to perform the method 1400 described with respect to FIG. 14, or any aspect related to it, including any operations described in relation to FIG. 14; the method 1600 described with respect to FIG. 16, or any aspect related to it, including any operations described in relation to FIG. 16; and the method 1700 described with respect to FIG. 17, or any aspect related to it, including any operations described in relation to FIG. 17. Note that reference to a processor performing a function of communications device 1800 may include one or more processors performing that function of communications device 1800, such as in a distributed fashion.

In the depicted example, computer-readable medium/memory 1840 stores code (e.g., executable instructions), including code for obtaining 1845, code for sending 1850, code for communicating 1855, code for stop monitoring 1860, and code for performing 1865. Processing of the code 1845-1865 may enable and cause the communications device 1800 to perform the method 1400 described with respect to FIG. 14, or any aspect related to it; the method 1600 described with respect to FIG. 16, or any aspect related to it; and the method 1700 described with respect to FIG. 17, or any aspect related to it.

The one or more processors 1810 include circuitry configured to implement (e.g., execute) the code stored in the computer-readable medium/memory 1840, including circuitry for obtaining 1815, circuitry for sending 1820, circuitry for communicating 1825, circuitry for stop monitoring 1830, and circuitry for performing 1835. Processing with circuitry 1815-1835 may enable and cause the communications device 1800 to perform the method 1400 described with respect to FIG. 14, or any aspect related to it; the method 1600 described with respect to FIG. 16, or any aspect related to it; and the method 1700 described with respect to FIG. 17, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1875 and/or antenna 1880 of the communications device 1800 in FIG. 18, and/or one or more processors 1810 of the communications device 1800 in FIG. 18. Means for communicating, receiving or obtaining may include the one or more transceivers 324, one or more antennas 322, and/or processing system 316 of the UE 304 illustrated in FIG. 3, transceiver 1875 and/or antenna 1880 of the communications device 1800 in FIG. 18, and/or one or more processors 1810 of the communications device 1800 in FIG. 18. For example, means for monitoring and/or performing of the method 1400 described with respect to FIG. 14, or any aspect related to it, may include the one or more transceivers 324, one or more antenna 322 and/or processing system 316 of the UE 304 illustrated in FIG. 3, transceiver 1875 and/or antenna 1880 of the communications device 1800 in FIG. 18, and/or one or more processors 1810 of the communications device 1800 in FIG. 18.

FIG. 19 depicts aspects of an example communications device configured for wireless communications. In some aspects, communications device 1900 is a network entity, such as BS 102 of FIG. 1, first network entity 300 or second network entity 302 of FIG. 3, or a disaggregated base station as discussed with respect to FIG. 2.

The communications device 1900 includes a processing system 1905 coupled to a transceiver 1955 (e.g., a transmitter and/or a receiver) and/or a network interface 1965. The transceiver 1955 is configured to transmit and receive signals for the communications device 1900 via an antenna 1960, such as the various signals as described herein. The network interface 1965 is configured to obtain and send signals for the communications device 1900 via communications link(s), such as a backhaul link, midhaul link, and/or fronthaul link as described herein, such as with respect to FIG. 2. The processing system 1905 may be configured to perform processing functions for the communications device 1900, including processing signals received and/or to be transmitted by the communications device 1900.

The processing system 1905 includes one or more processors 1910 and a computer-readable medium/memory 1930. In various aspects, one or more processors 1910 may be representative of the one or more processors 308, as described with respect to FIG. 3. The one or more processors 1910 are coupled to the computer-readable medium/memory 1930 via a bus 1950. In certain aspects, the computer-readable medium/memory 1930 is configured to store instructions (e.g., computer-executable code), including code 1935-1945, that when executed by the one or more processors 1910, cause the one or more processors 1910 to perform the method 1500 described with respect to FIG. 15, or any aspect related to it, including any operations described in relation to FIG. 15. The computer-readable medium/memory 1930 is a non-transitory computer-readable medium/memory. Note that reference to a processor of communications device 1900 performing a function may include one or more processors of communications device 1900 performing that function, such as in a distributed fashion.

In the depicted example, the computer-readable medium/memory 1930 stores code (e.g., executable instructions), including code for sending 1935, code for obtaining 1940, and code for communicating 1945. Processing of the code 1935-1945 may enable and cause the communications device 1900 to perform the method 1500 described with respect to FIG. 15, or any aspect related to it.

The one or more processors 1910 include circuitry configured to implement (e.g., execute) the code stored in the computer-readable medium/memory 1930, including circuitry for sending 1915, circuitry for obtaining 1920, and circuitry for communicating 1925. Processing with circuitry 1915-1925 may enable and cause the communications device 1900 to perform the method 1500 described with respect to FIG. 15, or any aspect related to it.

Various components of the communications device 1900 may provide means for performing the method 1500 described with respect to FIG. 15, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1955, antenna 1960, and/or network interface 1965 of the communications device 1900 in FIG. 19, and/or one or more processors 1910 of the communications device 1900 in FIG. 19. Means for communicating, receiving or obtaining may include the one or more transceivers 312, one or more antennas 314, and/or processing system 306 of the first network entity 300 or the second network entity 302 illustrated in FIG. 3, transceiver 1955, antenna 1960, and/or network interface 1965 of the communications device 1900 in FIG. 19, and/or one or more processors 1910 of the communications device 1900 in FIG. 19.

### Example Clauses

Implementation examples are described in the following numbered clauses:

Clause 1: A method for wireless communications by a user equipment comprising: obtaining, from a network entity, a DCI comprising an indication of a BWP switch, the indication of the BWP switch comprising a BWP indicator, the BWP indicator comprising an indication of a second BWP different than a first BWP, the first BWP being a currently active BWP; sending, to the network entity, a HARQ feedback; and communicating with the network entity on the second BWP after a configured amount of time configured for the BWP switch, wherein the configured amount of time starts after sending the HARQ feedback.

Clause 2: The method of Clause 1, wherein the DCI comprises a downlink DCI format with no scheduling information for a PDSCH.

Clause 3: The method of Clause 2, further comprising stopping monitoring or communicating on the first BWP during the configured amount of time.

Clause 4: The method of Clause 2, wherein sending the HARQ feedback comprises sending the HARQ feedback on the first BWP when the first BWP is on a primary cell of the user equipment.

Clause 5: The method of Clause 2, wherein the BWP switch comprises both a downlink BWP switch and an uplink BWP switch for TDD.

Clause 6: The method of Clause 2, wherein the BWP indicator further comprises an indication of a third BWP for FDD, wherein the second BWP is associated with a downlink BWP switch and the third BWP is a target BWP of an uplink BWP switch.

Clause 7: The method of Clause 6, wherein the BWP indicator comprises a first BWP indicator associated with the downlink BWP switch and a second BWP indicator associated with the uplink BWP switch.

Clause 8: The method of Clause 6, wherein the BWP indicator comprises an indication of a pair of identifiers comprising a downlink BWP identifier and an uplink BWP identifier.

Clause 9: The method of Clause 6, wherein the BWP indicator comprises a BWP identifier and a value indicating whether the BWP identifier is a downlink BWP identifier or an uplink BWP identifier.

Clause 10: The method of Clause 2, wherein the DCI comprises a CRC scrambled by a C-RNTI or a CS-RNTI associated with the user equipment.

Clause 11: The method of Clause 2, wherein the DCI comprises one or more configured values indicative of (i) having no scheduling information for the PDSCH and (ii) a condition for triggering the BWP switch.

Clause 12: The method of Clause 11, wherein the one or more configured values are configured as part of at least one of: a FDRA field, a RV field, a MCS field, an NDI field, or a TDRA field.

Clause 13: The method of Clause 12, wherein at least one configured value of the one or more configured values indicates a slot for performing the BWP switch.

Clause 14: The method of any one of Clauses 1-13, wherein the DCI comprises a downlink DCI format with scheduling information for a PDSCH, wherein the method further comprises performing the BWP switch based on the PDSCH being successfully decoded, wherein the HARQ feedback comprises an ACK for the PDSCH.

Clause 15: A method for wireless communications by a network entity comprising: sending a DCI comprising an indication of a BWP switch, the indication of the BWP switch comprising a BWP indicator, the BWP indicator comprising an indication of a second BWP different than a first BWP, the first BWP being a currently active BWP; obtaining a HARQ feedback; and communicating with a user equipment on the second BWP after a configured amount of time configured for the BWP switch, the BWP switch being based at least in part on the HARQ feedback.

Clause 16: The method of Clause 15, wherein the DCI comprises a downlink DCI format with no scheduling information for a PDSCH.

Clause 17: The method of any one of Clauses 15-16, wherein the DCI comprises a downlink DCI format with scheduling information for a PDSCH.

Clause 18: A method of wireless communications by a user equipment, comprising: obtaining, from a network entity, a DCI in accordance with a downlink DCI format and comprising scheduling information for a PDSCH; obtaining the PDSCH in accordance with the scheduling information, the PDSCH comprising a MAC CE, the MAC CE comprising an indication of a BWP switch, the indication of the BWP switch comprising a BWP indicator, the BWP indicator comprising an indication of a second BWP different than a first BWP, the first BWP being a currently active BWP; sending, to the network entity, a HARQ feedback for the PDSCH; and communicating with the network entity on the second BWP after a first configured amount of time configured for the BWP switch.

Clause 19: The method of Clause 18, wherein the first configured amount of time begins after a second amount of time after sending the HARQ feedback, the second amount of time associated with the MAC CE.

Clause 20: The method of any one of Clauses 18-19, wherein the MAC CE comprises, for a FDD cell, an indication of one of: a downlink target BWP; an uplink target BWP; or the downlink target BWP and the uplink target BWP.

Clause 21: The method of any one of Clauses 18-20, wherein the MAC CE comprises at least one of: an applicable serving cell index; one or more of a downlink target BWP identifier or an uplink target BWP identifier; or one or more parameter updates.

Clause 22: A method of wireless communications by a user equipment, comprising: obtaining, from a network entity, a DCI in accordance with an uplink DCI format and comprising scheduling information for a PUSCH, the DCI comprising an indication of a BWP switch, the indication of the BWP switch comprising a BWP indicator, the BWP indicator comprising an indication of a second BWP different than a first BWP, the first BWP being a currently active BWP; sending the PUSCH in accordance with the scheduling information; and communicating with the network entity on the second BWP after a configured amount of time after sending the PUSCH.

Clause 23: One or more apparatuses, comprising: one or more memories comprising executable instructions; and one or more processors configured to execute the executable instructions and cause the one or more apparatuses to perform a method in accordance with any one of Clauses 1-22.

Clause 24: One or more apparatuses configured for wireless communications, comprising: one or more memories; and one or more processors, coupled to the one or more memories, configured to cause the one or more apparatuses to perform a method in accordance with any one of Clauses 1-22.

Clause 25: One or more apparatuses configured for wireless communications, comprising: one or more memories; and one or more processors, coupled to the one or more memories, configured to perform a method in accordance with any one of Clauses 1-22.

Clause 26: One or more apparatuses, comprising means for performing a method in accordance with any one of Clauses 1-22.

Clause 27: One or more non-transitory computer-readable media comprising executable instructions that, when executed by one or more processors of one or more apparatuses, cause the one or more apparatuses to perform a method in accordance with any one of Clauses 1-22.

Clause 28: One or more computer program products embodied on one or more computer-readable storage media comprising code for performing a method in accordance with any one of Clauses 1-22.

Clause 29: One or more apparatuses configured for wireless communications, comprising: a processing system that includes one or more processors and one or more memories coupled with the one or more processors, the processing system configured to cause the one or more apparatuses to perform a method in accordance with any one of Clauses 1-22.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment to:
obtain, from a network entity, a downlink control information (DCI) comprising an indication of a bandwidth part (BWP) switch, the indication of the BWP switch comprising a BWP indicator, the BWP indicator comprising an indication of a second BWP different than a first BWP, the first BWP being a currently active BWP;
send, to the network entity, a hybrid automatic repeat request (HARQ) feedback; and
communicate with the network entity on the second BWP after a configured amount of time configured for the BWP switch,
wherein the configured amount of time starts after sending the HARQ feedback.

2. The apparatus of claim 1, wherein the DCI comprises a downlink DCI format with no scheduling information for a physical downlink shared channel (PDSCH).

3. The apparatus of claim 2, wherein the processing system is further configured to cause the user equipment to stop monitoring or communicating on the first BWP during the configured amount of time.

4. The apparatus of claim 2, wherein to cause the user equipment to send the HARQ feedback, the processing system is configured to cause the user equipment to send the HARQ feedback on the first BWP when the first BWP is on a primary cell of the user equipment.

5. The apparatus of claim 2, wherein the BWP switch comprises both a downlink BWP switch and an uplink BWP switch for time division duplexing (TDD).

6. The apparatus of claim 2, wherein the BWP indicator further comprises an indication of a third BWP for frequency division duplexing (FDD), wherein the second BWP is associated with a downlink BWP switch and the third BWP is a target BWP of an uplink BWP switch.

7. The apparatus of claim 6, wherein the BWP indicator comprises a first BWP indicator associated with the downlink BWP switch and a second BWP indicator associated with the uplink BWP switch.

8. The apparatus of claim 6, wherein the BWP indicator comprises an indication of a pair of identifiers comprising a downlink BWP identifier and an uplink BWP identifier.

9. The apparatus of claim 6, wherein the BWP indicator comprises a BWP identifier and a value indicating whether the BWP identifier is a downlink BWP identifier or an uplink BWP identifier.

10. The apparatus of claim 2, wherein the DCI comprises a cyclic redundancy check (CRC) scrambled by a cell radio network temporary identifier (C-RNTI) or a configured scheduling radio network temporary identifier (CS-RNTI) associated with the user equipment.

11. The apparatus of claim 2, wherein the DCI comprises one or more configured values indicative of (i) having no scheduling information for the PDSCH and (ii) a condition for triggering the BWP switch.

12. The apparatus of claim 11, wherein the one or more configured values are configured as part of at least one of:
a frequency domain resource allocation (FDRA) field,
a redundancy version (RV) field,
a modulation and coding scheme (MCS) field,
a new data indicator (NDI) field, or
a time domain resource allocation (TDRA) field.

13. The apparatus of claim 12, wherein at least one configured value of the one or more configured values indicates a slot for performing the BWP switch.

14. The apparatus of claim 1, wherein the DCI comprises a downlink DCI format with scheduling information for a physical downlink shared channel (PDSCH), wherein the processing system is configured to cause the user equipment to perform the BWP switch based on the PDSCH being successfully decoded, wherein the HARQ feedback comprises an acknowledgement (ACK) for the PDSCH.

15. An apparatus for wireless communications, comprising a processing system that includes one or more processors and one or more memories coupled with the one or more processors, the processing system configured to cause a network entity to:
send a downlink control information (DCI) comprising an indication of a bandwidth part (BWP) switch, the indication of the BWP switch comprising a BWP indicator, the BWP indicator comprising an indication of a second BWP different than a first BWP, the first BWP being a currently active BWP;
obtain a hybrid automatic repeat request (HARQ) feedback; and
communicate with a user equipment on the second BWP after a configured amount of time configured for the BWP switch, the BWP switch being based at least in part on the HARQ feedback.

16. The apparatus of claim 15, wherein the DCI comprises a downlink DCI format with no scheduling information for a physical downlink shared channel (PDSCH).

17. The apparatus of claim 15, wherein the DCI comprises a downlink DCI format with scheduling information for a physical downlink shared channel (PDSCH).

18. A method for wireless communications by a user equipment, comprising:
obtaining, from a network entity, a downlink control information (DCI) comprising an indication of a bandwidth part (BWP) switch, the indication of the BWP switch comprising a BWP indicator, the BWP indicator comprising an indication of a second BWP different than a first BWP, the first BWP being a currently active BWP;
sending, to the network entity, a hybrid automatic repeat request (HARQ) feedback; and
communicating with the network entity on the second BWP after a configured amount of time configured for the BWP switch,
wherein the configured amount of time starts after sending the HARQ feedback.

19. The method of claim 18, wherein the DCI comprises a downlink DCI format with no scheduling information for a physical downlink shared channel (PDSCH).

20. The method of claim 19, wherein sending the HARQ feedback comprises sending the HARQ feedback on the first BWP when the first BWP is on a primary cell of the user equipment.

21. The method of claim 19, wherein the BWP switch comprises both a downlink BWP switch and an uplink BWP switch for time division duplexing (TDD).

22. The method of claim 19, wherein the BWP indicator further comprises an indication of a third BWP for frequency division duplexing (FDD), wherein the second BWP is associated with a downlink BWP switch and the third BWP is a target BWP of an uplink BWP switch.

23. The method of claim 22, wherein the BWP indicator comprises a first BWP indicator associated with the downlink BWP switch and a second BWP indicator associated with the uplink BWP switch.

24. The method of claim 22, wherein the BWP indicator comprises an indication of a pair of identifiers comprising a downlink BWP identifier and an uplink BWP identifier.

25. The method of claim 22, wherein the BWP indicator comprises a BWP identifier and a value indicating whether the BWP identifier is a downlink BWP identifier or an uplink BWP identifier.

26. The method of claim 19, wherein the DCI comprises a cyclic redundancy check (CRC) scrambled by a cell radio network temporary identifier (C-RNTI) or a configured scheduling radio network temporary identifier (CS-RNTI) associated with the user equipment.

27. The method of claim 19, wherein the DCI comprises one or more configured values indicative of (i) having no scheduling information for the PDSCH and (ii) a condition for triggering the BWP switch.

28. The method of claim 27, wherein the one or more configured values are configured as part of at least one of:
a frequency domain resource allocation (FDRA) field,
a redundancy version (RV) field,
a modulation and coding scheme (MCS) field,
a new data indicator (NDI) field, or
a time domain resource allocation (TDRA) field.

29. The method of claim 18, wherein the DCI comprises a downlink DCI format with scheduling information for a physical downlink shared channel (PDSCH), wherein the method further comprises performing the BWP switch based on the PDSCH being successfully decoded, wherein the HARQ feedback comprises an acknowledgement (ACK) for the PDSCH.

30. A method for wireless communications by a network entity, comprising:
sending a downlink control information (DCI) comprising an indication of a bandwidth part (BWP) switch, the indication of the BWP switch comprising a BWP indicator, the BWP indicator comprising an indication of a second BWP different than a first BWP, the first BWP being a currently active BWP;
obtaining a hybrid automatic repeat request (HARQ) feedback; and
communicating with a user equipment on the second BWP after a configured amount of time configured for the BWP switch, the BWP switch being based at least in part on the HARQ feedback.
